(19) United States
(12) Patent Application Publication
(10) Pub. No.: US 2025/0358714 A1
(43) Pub. Date: Nov. 20, 2025

(54) SYNCHRONIZATION SIGNAL BLOCK DESIGN FOR MULTIPLE RADIO ACCESS TECHNOLOGIES

(71) Applicant: QUALCOMM Incorporated, San Diego, CA (US)

(72) Inventors: Kianoush HOSSEINI, San Diego, CA (US); Yan ZHOU, San Diego, CA (US); Jing SUN, San Diego, CA (US); Tao LUO, San Diego, CA (US); Aria HASANZADEZONUZY, Jersey City, NJ (US); Jing LEI, San Diego, CA (US); Kazuki TAKEDA, Minato-ku (JP); Jing JIANG, San Diego, CA (US)

(21) Appl. No.: 18/664,244

(22) Filed: May 14, 2024

(51) Int. Cl. H04W 48/10; H04W 48/02

(52) U.S. Cl. CPC H04W 48/10; H04W 48/02

(57) ABSTRACT

Various aspects of the present disclosure generally relate to wireless communication. In some aspects, a user equipment (UE) may receive a synchronization signal block (SSB), wherein the SSB is associated with a first radio access technology (RAT) or a second RAT according to at least one of: a configuration of a synchronization signal, a configuration of a broadcast channel of the SSB, whether a control channel is scheduled by the SSB, or barring information associated with the SSB. The UE may obtain system information in accordance with the SSB. Numerous other aspects are described.

### FIELD OF THE DISCLOSURE

Aspects of the present disclosure generally relate to wireless communication and specifically relate to techniques, apparatuses, and methods for synchronization signal block design for multiple radio access technologies.

### BACKGROUND

Wireless communication systems are widely deployed to provide various services that may include carrying voice, text, messaging, video, data, and/or other traffic. The services may include unicast, multicast, and/or broadcast services, among other examples. Typical wireless communication systems may employ multiple-access radio access technologies (RATs) capable of supporting communication with multiple users by sharing available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

The above multiple-access RATs have been adopted in various telecommunication standards to provide common protocols that enable different wireless communication devices to communicate on a municipal, national, regional, or global level. An example telecommunication standard is New Radio (NR). NR, which may also be referred to as 5G, is part of a continuous mobile broadband evolution promulgated by the Third Generation Partnership Project (3GPP). NR (and other mobile broadband evolutions beyond NR) may be designed to better support Internet of things (IoT) and reduced capability device deployments, industrial connectivity, millimeter wave (mmWave) expansion, licensed and unlicensed spectrum access, non-terrestrial network (NTN) deployment, sidelink and other device-to-device direct communication technologies (for example, cellular vehicle-to-everything (CV2X) communication), massive multiple-input multiple-output (MIMO), disaggregated network architectures and network topology expansions, multiple-subscriber implementations, high-precision positioning, and/or radio frequency (RF) sensing, among other examples. As the demand for mobile broadband access continues to increase, further improvements in NR may be implemented, and other radio access technologies such as 6G may be introduced, to further advance mobile broadband evolution.

### SUMMARY

In some aspects, a method of wireless communication performed by a user equipment (UE) includes receiving a synchronization signal block (SSB), wherein the SSB is associated with a first radio access technology (RAT) or a second RAT according to at least one of: a configuration of a synchronization signal, a configuration of a broadcast channel of the SSB, whether a control channel is scheduled by the SSB, or barring information associated with the SSB; and obtaining system information in accordance with the SSB.

In some aspects, a method of wireless communication performed by a network node includes transmitting an SSB, wherein the SSB is associated with a first RAT or a second RAT according to at least one of: a configuration of a synchronization signal, a configuration of a broadcast channel of the SSB, whether a control channel is scheduled by the SSB, or barring information associated with the SSB; and transmitting system information in accordance with the SSB.

In some aspects, an apparatus for wireless communication at a UE includes one or more memories; and one or more processors, coupled to the one or more memories, configured to cause the UE to: receive an SSB, wherein the SSB is associated with a first RAT or a second RAT according to at least one of: a configuration of a synchronization signal, a configuration of a broadcast channel of the SSB, whether a control channel is scheduled by the SSB, or barring information associated with the SSB; and obtain system information in accordance with the SSB.

In some aspects, an apparatus for wireless communication at a network node includes one or more memories; and one or more processors, coupled to the one or more memories, configured to cause the network node to: transmit an SSB, wherein the SSB is associated with a first RAT or a second RAT according to at least one of: a configuration of a synchronization signal, a configuration of a broadcast channel of the SSB, whether a control channel is scheduled by the SSB, or barring information associated with the SSB; and transmit system information in accordance with the SSB.

In some aspects, a non-transitory computer-readable medium storing a set of instructions for wireless communication includes one or more instructions that, when executed by one or more processors of a UE, cause the UE to: receive an SSB, wherein the SSB is associated with a first RAT or a second RAT according to at least one of: a configuration of a synchronization signal, a configuration of a broadcast channel of the SSB, whether a control channel is scheduled by the SSB, or barring information associated with the SSB; and obtain system information in accordance with the SSB.

In some aspects, a non-transitory computer-readable medium storing a set of instructions for wireless communication includes one or more instructions that, when executed by one or more processors of a network node, cause the network node to: transmit an SSB, wherein the SSB is associated with a first RAT or a second RAT according to at least one of: a configuration of a synchronization signal, a configuration of a broadcast channel of the SSB, whether a control channel is scheduled by the SSB, or barring information associated with the SSB; and transmit system information in accordance with the SSB.

In some aspects, an apparatus for wireless communication includes means for receiving an SSB, wherein the SSB is associated with a first RAT or a second RAT according to at least one of: a configuration of a synchronization signal, a configuration of a broadcast channel of the SSB, whether a control channel is scheduled by the SSB, or barring information associated with the SSB; and means for obtaining system information in accordance with the SSB.

In some aspects, an apparatus for wireless communication includes means for transmitting an SSB, wherein the SSB is associated with a first RAT or a second RAT according to at least one of: a configuration of a synchronization signal, a configuration of a broadcast channel of the SSB, whether a control channel is scheduled by the SSB, or barring information associated with the SSB; and means for transmitting system information in accordance with the SSB.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, the specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure, but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network in accordance with the present disclosure.

FIG. 2 is a diagram illustrating an example network node in communication with an example user equipment (UE) in a wireless network in accordance with the present disclosure.

FIG. 3 is a diagram illustrating an example disaggregated base station architecture in accordance with the present disclosure.

FIG. 4 is a diagram illustrating an example of a synchronization signal (SS) hierarchy, in accordance with the present disclosure.

FIG. 5 is a diagram illustrating an example of an SS block (SSB) configuration for an SSB, in accordance with the present disclosure.

FIG. 6 is a diagram illustrating an example of SSB transmission in a multiple radio access technology (RAT) band, in accordance with the present disclosure.

FIG. 7 is a diagram illustrating an example of a band or cell in which only one RAT is supported, in accordance with the present disclosure.

FIG. 8 is a diagram illustrating an example of signaling associated with transmission of separate SSBs for a first RAT and a second RAT, in accordance with the present disclosure.

FIG. 9 is a diagram illustrating an example of signaling associated with joint transmission of an SSB for a first RAT and a second RAT, in accordance with the present disclosure.

FIG. 10 is a diagram illustrating an example of an SSB for shared transmission that includes a first physical broadcast channel (PBCH) and a second PBCH in accordance with the present disclosure.

FIG. 11 is a diagram illustrating an example process performed, for example, at a UE or an apparatus of a UE, in accordance with the present disclosure.

FIG. 12 is a diagram illustrating an example process performed, for example, at a network node or an apparatus of a network node, in accordance with the present disclosure.

FIG. 13 is a diagram of an example apparatus for wireless communication, in accordance with the present disclosure.

FIG. 14 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms and is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A radio access technology (RAT) may use a set of synchronization signals (sometimes referred to as pilots) to enable devices to communicate using the RAT. For example, synchronization signals may enable identification of a cell or device that uses the RAT, synchronization in time and frequency with the cell or device, and/or identification of where or when other information used to communicate with the cell or device is provided. A collection of such reference signals and/or other information is referred to herein as a synchronization signal block (SSB). In particular, 5G (used interchangeably herein with “NR”) uses an SSB that includes a primary synchronization signal (PSS), a secondary synchronization signal (SSS), and a physical broadcast channel (PBCH), where the PSS and SSS provide identification of the SSB and synchronization, and the PBCH identifies where and when the other information is provided.

5G is an example of a generation-based RAT. A “generation” of a generation-based RAT may provide a set of features. Devices (or entities, services, functions, etc.), such as a user equipment (UE) or a network node that support the generation may support the set of features. Given an earlier generation and a later generation of a generation-based RAT, a device that supports the earlier generation is generally not expected to support the later generation. A device that supports the later generation may or may not support the earlier generation. As an example, the earlier generation may be 5G and the later generation may be 6G. In this example, 5G may be referred to as a first-generation-based RAT and 6G may be referred to as a second-generation-based RAT. In some cases, the transition from a first-generation-based RAT to a second-generation-based RAT may involve transitioning cells from the first RAT to the second RAT (referred to as “refarming” these cells). Additionally, or alternatively, the transition may involve concurrently supporting the first RAT and the second RAT in a given area or cell (which may be referred to as multi-RAT spectrum sharing (MRSS)).

In some examples, certain features are shared across generation-based RATs. For example, both 4G (LTE) and 5G support various features such as duplexing modes, multiple-input multiple-output (MIMO), and carrier aggregation (CA). Additionally or alternatively, a given feature may be implemented in two generation-based RATs, but in a different way for each RAT. For example, in 4G, the physical downlink control channel (PDCCH) is transmitted in a fixed control region, whereas in 5G, the PDCCH is transmitted in a flexibly configurable control resource set (CORESET). In such examples, devices supporting the earlier generation-based RAT may not be capable of using the feature as implemented in the later generation-based RAT. In other examples, a feature may be newly implemented in a later generation-based RAT, such as integrated access and backhaul (IAB) and millimeter wave communication in 5G. There may be advantages to sharing features across generation-based RATs, as well as advantages to implementing a given feature in a different way across generation-based RATs.

Aspects of the present disclosure relate generally to an SSB in a first RAT (such as a first-generation-based RAT, which in one example may be 5G) and an SSB in a second RAT (such as a second-generation-based RAT, which in one example may be 6G). In some aspects, the SSB in the second RAT may be understandable only by UEs using the second RAT (for example, each of the synchronization signals and channels of the SSB in the second RAT may be redesigned relative to synchronization signals and channels of the SSB in the first RAT, or one or more synchronization signals or channels of the SSB in the second RAT may be redesigned such that UEs supporting the first RAT do not detect or decode the SSB in the second RAT). In some aspects, the SSB in the first RAT and the SSB in the second RAT share at least one synchronization signal or channel, and are transmitted separately from one another (for example, the SSB in the first RAT and the SSB in the second RAT may share a PSS and an SSS, and may differ in a configuration or placement of a PBCH, and the network may transmit a first SSB for the first RAT and a second SSB for the second RAT). In some aspects, the SSB in the first RAT and the SSB in the second RAT share at least one synchronization signal or channel and are transmitted jointly (e.g., in a shared fashion, on the same resources, such that one SSB is transmitted for the first RAT and the second RAT).

Aspects of the present disclosure may be used to realize one or more of the following potential advantages. Configuring an SSB for the second RAT that is understandable only by UEs using the second RAT may enable certain drawbacks, associated with the SSB in the first RAT, to be addressed. Also, sharing at least one synchronization signal or channel and using separate transmission may enable these drawbacks to be addressed with regard to non-shared synchronization signals or channels, while also enabling some hardware reuse between UEs using the first RAT and UEs using the second RAT. Sharing at least one synchronization signal or channel and transmitting the SSBs jointly may reduce complexity at the UE and the network (since hardware and outputs for search/cell acquisition/cell configuration can be reused), and may reduce network energy consumption relative to separately transmitting SSBs for the first RAT and the second RAT. Further details regarding these approaches are provided herein.

Multiple-access radio access technologies (RATs) have been adopted in various telecommunication standards to provide common protocols that enable wireless communication devices to communicate on a municipal, enterprise, national, regional, or global level. For example, 5G New Radio (NR) is part of a continuous mobile broadband evolution promulgated by the Third Generation Partnership Project (3GPP). 5G NR supports various technologies and use cases including enhanced mobile broadband (eMBB), ultra-reliable low-latency communication (URLLC), massive machine-type communication (mMTC), millimeter wave (mmWave) technology, beamforming, network slicing, edge computing, Internet of Things (IoT) connectivity and management, and network function virtualization (NFV).

As the demand for broadband access increases and as technologies supported by wireless communication networks evolve, further technological improvements may be adopted in or implemented for 5G NR or future RATs, such as 6G, to further advance the evolution of wireless communication for a wide variety of existing and new use cases and applications. Such technological improvements may be associated with new frequency band expansion, licensed and unlicensed spectrum access, overlapping spectrum use, small cell deployments, non-terrestrial network (NTN) deployments, disaggregated network architectures and network topology expansion, device aggregation, advanced duplex communication, sidelink and other device-to-device direct communication, IoT (including passive or ambient IoT) networks, reduced capability (RedCap) UE functionality, industrial connectivity, multiple-subscriber implementations, high-precision positioning, radio frequency (RF) sensing, and/or artificial intelligence or machine learning (AI/ML), among other examples. These technological improvements may support use cases such as wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples. The methods, operations, apparatuses, and techniques described herein may enable one or more of the foregoing technologies and/or support one or more of the foregoing use cases.

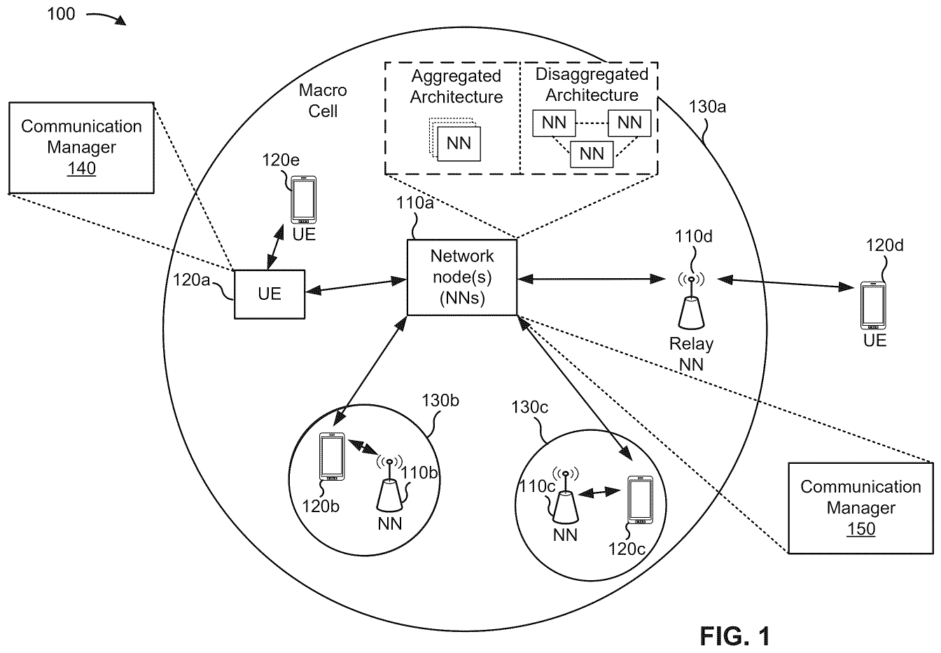

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110, shown as a network node (NN) 110a, a network node 110b, a network node 110c, and a network node 110d. The network nodes 110 may support communications with multiple UEs 120, shown as a UE 120a, a UE 120b, a UE 120c, a UE 120d, and a UE 120c.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency ranges. Examples of RATs include a 4G RAT, a 5G/NR RAT, and/or a 6G RAT, among other examples. In some examples, when multiple RATs are deployed in a given geographic area, each RAT in the geographic area may operate on different frequencies to avoid interference with one another.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHz). Although a portion of FR1 is greater than 6 GHz, FR1 is often referred to (interchangeably) as a “Sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into mid-band frequencies. Thus, “sub-6 GHz,” if used herein, may broadly refer to frequencies that are less than 6 GHZ, that are within FR1, and/or that are included in mid-band frequencies. Similarly, the term “millimeter wave,” if used herein, may broadly refer to frequencies that are included in mid-band frequencies, that are within FR2, FR4, FR4-a or FR4-1, or FR5, and/or that are within the EHF band. Higher frequency bands may extend 5G NR operation, 6G operation, and/or other RATs beyond 52.6 GHz. For example, each of FR4a, FR4-1, FR4, and FR5 falls within the EHF band. In some examples, the wireless communication network 100 may implement dynamic spectrum sharing (DSS), in which multiple RATs (for example, 4G/LTE and 5G/NR) are implemented with dynamic bandwidth allocation (for example, based on user demand) in a single frequency band. It is contemplated that the frequencies included in these operating bands (for example, FR1, FR2, FR3, FR4, FR4-a, FR4-1, and/or FR5) may be modified, and techniques described herein may be applicable to those modified frequency ranges.

A network node 110 may include one or more devices, components, or systems that enable communication between a UE 120 and one or more devices, components, or systems of the wireless communication network 100. A network node 110 may be, may include, or may also be referred to as an NR network node, a 5G network node, a 6G network node, a Node B, an eNB, a gNB, an access point (AP), a transmission reception point (TRP), a mobility element, a core, a network entity, a network element, a network equipment, and/or another type of device, component, or system included in a radio access network (RAN).

A network node 110 may be implemented as a single physical node (for example, a single physical structure) or may be implemented as two or more physical nodes (for example, two or more distinct physical structures). For example, a network node 110 may be a device or system that implements part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node (having an aggregated architecture), meaning that the network node 110 may implement a full radio protocol stack that is physically and logically integrated within a single node (for example, a single physical structure) in the wireless communication network 100. For example, an aggregated network node 110 may consist of a single standalone base station or a single TRP that uses a full radio protocol stack to enable or facilitate communication between a UE 120 and a core network of the wireless communication network 100.

Alternatively, and as also shown, a network node 110 may be a disaggregated network node (sometimes referred to as a disaggregated base station), meaning that the network node 110 may implement a radio protocol stack that is physically distributed and/or logically distributed among two or more nodes in the same geographic location or in different geographic locations. For example, a disaggregated network node may have a disaggregated architecture. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating base station functionality into multiple units that can be individually deployed.

The network nodes 110 of the wireless communication network 100 may include one or more central units (CUs), one or more distributed units (DUs), and/or one or more radio units (RUs). A CU may host one or more higher layer control functions, such as radio resource control (RRC) functions, packet data convergence protocol (PDCP) functions, and/or service data adaptation protocol (SDAP) functions, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host one or more lower PHY layer functions, such as a fast Fourier transform (FFT), an inverse FFT (iFFT), beamforming, physical random access channel (PRACH) extraction and filtering, and/or scheduling of resources for one or more UEs 120, among other examples. An RU may host RF processing functions or lower PHY layer functions, such as an FFT, an iFFT, beamforming, or PRACH extraction and filtering, among other examples, according to a functional split, such as a lower layer functional split. In such an architecture, each RU can be operated to handle over the air (OTA) communication with one or more UEs 120.

In some aspects, a single network node 110 may include a combination of one or more CUs, one or more DUs, and/or one or more RUs. Additionally or alternatively, a network node 110 may include one or more Near-Real Time (Near-RT) RAN Intelligent Controllers (RICs) and/or one or more Non-Real Time (Non-RT) RICs. In some examples, a CU, a DU, and/or an RU may be implemented as a virtual unit, such as a virtual central unit (VCU), a virtual distributed unit (VDU), or a virtual radio unit (VRU), among other examples. A virtual unit may be implemented as a virtual network function, such as associated with a cloud deployment.

Some network nodes 110 (for example, a base station, an RU, or a TRP) may provide communication coverage for a particular geographic area. In the 3GPP, the term “cell” can refer to a coverage area of a network node 110 or to a network node 110 itself, depending on the context in which the term is used. A network node 110 may support one or multiple (for example, three) cells. In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (for example, a home) and may allow restricted access by UEs 120 having association with the femto cell (for example, UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In some examples, a cell may not necessarily be stationary. For example, the geographic area of the cell may move according to the location of an associated mobile network node 110 (for example, a train, a satellite base station, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. In the example shown in FIG. 1, the network node 110a may be a macro network node for a macro cell 130a, the network node 110b may be a pico network node for a pico cell 130b, and the network node 110c may be a femto network node for a femto cell 130c. Various different types of network nodes 110 may generally transmit at different power levels, serve different coverage areas, and/or have different impacts on interference in the wireless communication network 100 than other types of network nodes 110. For example, macro network nodes may have a high transmit power level (for example, 5 to 40 watts), whereas pico network nodes, femto network nodes, and relay network nodes may have lower transmit power levels (for example, 0.1 to 2 watts).

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink channels may include one or more control channels and one or more data channels. A downlink control channel may be used to transmit downlink control information (DCI) (for example, scheduling information, reference signals, and/or configuration information) from a network node 110 to a UE 120. A downlink data channel may be used to transmit downlink data (for example, user data associated with a UE 120) from a network node 110 to a UE 120. Downlink control channels may include one or more physical downlink control channels (PDCCHs), and downlink data channels may include one or more physical downlink shared channels (PDSCHs). Uplink channels may similarly include one or more control channels and one or more data channels. An uplink control channel may be used to transmit uplink control information (UCI) (for example, reference signals and/or feedback corresponding to one or more downlink transmissions) from a UE 120 to a network node 110. An uplink data channel may be used to transmit uplink data (for example, user data associated with a UE 120) from a UE 120 to a network node 110. Uplink control channels may include one or more physical uplink control channels (PUCCHs), and uplink data channels may include one or more physical uplink shared channels (PUSCHs). The downlink and the uplink May each include a set of resources on which the network node 110 and the UE 120 may communicate.

Downlink and uplink resources may include time domain resources (frames, subframes, slots, and/or symbols), frequency domain resources (frequency bands, component carriers, subcarriers, resource blocks, and/or resource elements), and/or spatial domain resources (particular transmit directions and/or beam parameters). Frequency domain resources of some bands may be subdivided into bandwidth parts (BWPs). A BWP may be a continuous block of frequency domain resources (for example, a continuous block of resource blocks) that are allocated for one or more UEs 120. A UE 120 may be configured with both an uplink BWP and a downlink BWP (where the uplink BWP and the downlink BWP may be the same BWP or different BWPs). A BWP may be dynamically configured (for example, by a network node 110 transmitting a DCI configuration to the one or more UEs 120) and/or reconfigured, which means that a BWP can be adjusted in real-time (or near-real-time) based on changing network conditions in the wireless communication network 100 and/or based on the specific requirements of the one or more UEs 120. This enables more efficient use of the available frequency domain resources in the wireless communication network 100 because fewer frequency domain resources may be allocated to a BWP for a UE 120 (which may reduce the quantity of frequency domain resources that a UE 120 is required to monitor), leaving more frequency domain resources to be spread across multiple UEs 120. Thus, BWPs may also assist in the implementation of lower-capability UEs 120 by facilitating the configuration of smaller bandwidths for communication by such UEs 120.

As described above, in some aspects, the wireless communication network 100 may be, may include, or may be included in, an IAB network. In an IAB network, at least one network node 110 is an anchor network node that communicates with a core network. An anchor network node 110 may also be referred to as an IAB donor (or “IAB-donor”). The anchor network node 110 may connect to the core network via a wired backhaul link. For example, an Ng interface of the anchor network node 110 may terminate at the core network. Additionally or alternatively, an anchor network node 110 may connect to one or more devices of the core network that provide a core access and mobility management function (AMF). An IAB network also generally includes multiple non-anchor network nodes 110, which may also be referred to as relay network nodes or simply as IAB nodes (or “IAB-nodes”). Each non-anchor network node 110 may communicate directly with the anchor network node 110 via a wireless backhaul link to access the core network, or may communicate indirectly with the anchor network node 110 via one or more other non-anchor network nodes 110 and associated wireless backhaul links that form a backhaul path to the core network. Some anchor network node 110 or other non-anchor network node 110 may also communicate directly with one or more UEs 120 via wireless access links that carry access traffic. In some examples, network resources for wireless communication (such as time resources, frequency resources, and/or spatial resources) may be shared between access links and backhaul links.

In some examples, any network node 110 that relays communications may be referred to as a relay network node, a relay station, or simply as a relay. A relay may receive a transmission of a communication from an upstream station (for example, another network node 110 or a UE 120) and transmit the communication to a downstream station (for example, a UE 120 or another network node 110). In this case, the wireless communication network 100 may include or be referred to as a “multi-hop network.” In the example shown in FIG. 1, the network node 110d (for example, a relay network node) may communicate with the network node 110a (for example, a macro network node) and the UE 120d in order to facilitate communication between the network node 110a and the UE 120d. Additionally or alternatively, a UE 120 may be or may operate as a relay station that can relay transmissions to or from other UEs 120. A UE 120 that relays communications may be referred to as a UE relay or a relay UE, among other examples.

The UEs 120 may be physically dispersed throughout the wireless communication network 100, and each UE 120 may be stationary or mobile. A UE 120 may be, may include, or may be included in an access terminal, another terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (for example, a smart watch, smart clothing, smart glasses, a smart wristband, and/or smart jewelry, such as a smart ring or a smart bracelet), an entertainment device (for example, a music device, a video device, and/or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

A UE 120 and/or a network node 110 may include one or more chips, system-on-chips (SoCs), chipsets, packages, or devices that individually or collectively constitute or comprise a processing system. The processing system includes processor (or “processing”) circuitry in the form of one or multiple processors, microprocessors, processing units (such as central processing units (CPUs), graphics processing units (GPUs), neural processing units (NPUs) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set, or may include the group of processors all being configured or configurable to perform the set of functions.

The processing system may further include memory circuitry in the form of one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code (such as software) that, when executed by one or more of the processors, may configure one or more of the processors to perform various functions or operations described herein. Additionally or alternatively, in some examples, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G, or 6G compliant) modem). In some implementations, one or more processors of the processing system include or implement one or more of the modems. The processing system may further include or be coupled with multiple radios (collectively “the radio”), multiple RF chains, or multiple transceivers, each of which may in turn be coupled with one or more of multiple antennas. In some implementations, one or more processors of the processing system include or implement one or more of the radios, RF chains or transceivers. The UE 120 may include or may be included in a housing that houses components associated with the UE 120 including the processing system.

In some examples, two or more UEs 120 (for example, shown as UE 120a and UE 120c) may communicate directly with one another using sidelink communications (for example, without communicating by way of a network node 110 as an intermediary). As an example, the UE 120a may directly transmit data, control information, or other signaling as a sidelink communication to the UE 120c. This is in contrast to, for example, the UE 120a first transmitting data in an UL communication to a network node 110, which then transmits the data to the UE 120e in a DL communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. In some other deployments and configurations, a UE 120 (instead of a network node 110) may perform, or collaborate or negotiate with one or more other UEs to perform, scheduling operations, resource selection operations, and/or other operations for sidelink communications.

In some aspects, the UE 120 may include a communication manager 140. As described in more detail elsewhere herein, the communication manager 140 may receive an SSB, wherein the SSB is associated with a first RAT or a second RAT according to at least one of: a configuration of a synchronization signal, a configuration of a broadcast channel of the SSB, whether a control channel is scheduled by the SSB, or barring information associated with the SSB; and obtain system information in accordance with the SSB. Additionally, or alternatively, the communication manager 140 may perform one or more other operations described herein.

In some aspects, the network node 110 may include a communication manager 150. As described in more detail elsewhere herein, the communication manager 150 may transmit an SSB, wherein the SSB is associated with a first RAT or a second RAT according to at least one of: a configuration of a synchronization signal, a configuration of a broadcast channel of the SSB, whether a control channel is scheduled by the SSB, or barring information associated with the SSB; and transmit system information in accordance with the SSB. Additionally, or alternatively, the communication manager 150 may perform one or more other operations described herein.

As indicated above, FIG. 1 is provided as an example. Other examples may differ from what is described with regard to FIG. 1.

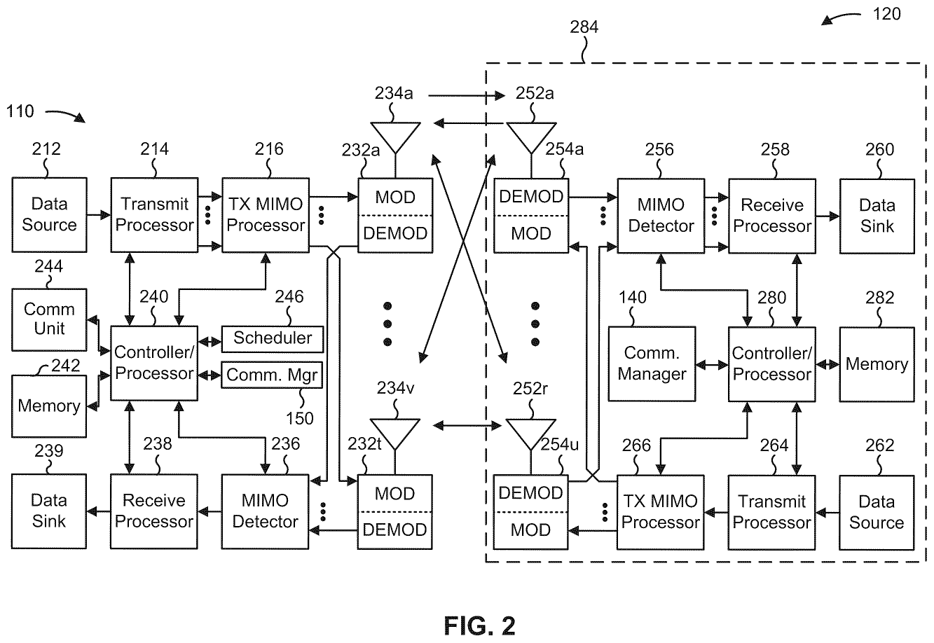

FIG. 2 is a diagram illustrating an example network node 110 in communication with an example UE 120 in a wireless network in accordance with the present disclosure.

As shown in FIG. 2, the network node 110 may include a data source 212, a transmit processor 214, a transmit (TX) MIMO processor 216, a set of modems 232 (shown as 232a through 232t, where t≥1), a set of antennas 234 (shown as 234a through 234v, where v≥1), a MIMO detector 236, a receive processor 238, a data sink 239, a controller/processor 240, a memory 242, a communication unit 244, a scheduler 246, and/or a communication manager 150, among other examples. In some configurations, one or a combination of the antenna(s) 234, the modem(s) 232, the MIMO detector 236, the receive processor 238, the transmit processor 214, and/or the TX MIMO processor 216 may be included in a transceiver of the network node 110. The transceiver may be under control of and used by one or more processors, such as the controller/processor 240, and in some aspects in conjunction with processor-readable code stored in the memory 242, to perform aspects of the methods, processes, and/or operations described herein. In some aspects, the network node 110 may include one or more interfaces, communication components, and/or other components that facilitate communication with the UE 120 or another network node.

The terms “processor,” “controller,” or “controller/processor” may refer to one or more controllers and/or one or more processors. For example, reference to “a/the processor,” “a/the controller/processor,” or the like (in the singular) should be understood to refer to any one or more of the processors described in connection with FIG. 2, such as a single processor or a combination of multiple different processors. Reference to “one or more processors” should be understood to refer to any one or more of the processors described in connection with FIG. 2. For example, one or more processors of the network node 110 may include transmit processor 214, TX MIMO processor 216, MIMO detector 236, receive processor 238, and/or controller/processor 240. Similarly, one or more processors of the UE 120 may include MIMO detector 256, receive processor 258, transmit processor 264, TX MIMO processor 266, and/or controller/processor 280.

In some aspects, a single processor may perform all of the operations described as being performed by the one or more processors. In some aspects, a first set of (one or more) processors of the one or more processors may perform a first operation described as being performed by the one or more processors, and a second set of (one or more) processors of the one or more processors may perform a second operation described as being performed by the one or more processors. The first set of processors and the second set of processors may be the same set of processors or may be different sets of processors. Reference to “one or more memories” should be understood to refer to any one or more memories of a corresponding device, such as the memory described in connection with FIG. 2. For example, operation described as being performed by one or more memories can be performed by the same subset of the one or more memories or different subsets of the one or more memories.

For downlink communication from the network node 110 to the UE 120, the transmit processor 214 may receive data (“downlink data”) intended for the UE 120 (or a set of UEs that includes the UE 120) from the data source 212 (such as a data pipeline or a data queue). In some examples, the transmit processor 214 may select one or more MCSs for the UE 120 in accordance with one or more channel quality indicators (CQIs) received from the UE 120. The network node 110 may process the data (for example, including encoding the data) for transmission to the UE 120 on a downlink in accordance with the MCS(s) selected for the UE 120 to generate data symbols. The transmit processor 214 may process system information (for example, semi-static resource partitioning information (SRPI)) and/or control information (for example, CQI requests, grants, and/or upper layer signaling) and provide overhead symbols and/or control symbols. The transmit processor 214 may generate reference symbols for reference signals (for example, a cell-specific reference signal (CRS), a demodulation reference signal (DMRS), or a channel state information (CSI) reference signal (CSI-RS)) and/or synchronization signals (for example, a primary synchronization signal (PSS) or a secondary synchronization signals (SSS)).

The TX MIMO processor 216 may perform spatial processing (for example, precoding) on the data symbols, the control symbols, the overhead symbols, and/or the reference symbols, if applicable, and may provide a set of output symbol streams (for example, T output symbol streams) to the set of modems 232. For example, each output symbol stream may be provided to a respective modulator component (shown as MOD) of a modem 232. Each modem 232 may use the respective modulator component to process (for example, to modulate) a respective output symbol stream (for example, for orthogonal frequency division multiplexing (OFDM)) to obtain an output sample stream. Each modem 232 may further use the respective modulator component to process (for example, convert to analog, amplify, filter, and/or upconvert) the output sample stream to obtain a time domain downlink signal. The modems 232a through 232t may together transmit a set of downlink signals (for example, T downlink signals) via the corresponding set of antennas 234.

A downlink signal may include a DCI communication, a MAC control element (MAC-CE) communication, an RRC communication, a downlink reference signal, or another type of downlink communication. Downlink signals may be transmitted on a PDCCH, a PDSCH, and/or on another downlink channel. A downlink signal may carry one or more transport blocks (TBs) of data. A TB may be a unit of data that is transmitted over an air interface in the wireless communication network 100. A data stream (for example, from the data source 212) may be encoded into multiple TBs for transmission over the air interface. The quantity of TBs used to carry the data associated with a particular data stream may be associated with a TB size common to the multiple TBs. The TB size may be based on or otherwise associated with radio channel conditions of the air interface, the MCS used for encoding the data, the downlink resources allocated for transmitting the data, and/or another parameter. In general, the larger the TB size, the greater the amount of data that can be transmitted in a single transmission, which reduces signaling overhead. However, larger TB sizes May be more prone to transmission and/or reception errors than smaller TB sizes, but such errors may be mitigated by more robust error correction techniques.

For uplink communication from the UE 120 to the network node 110, uplink signals from the UE 120 may be received by an antenna 234, may be processed by a modem 232 (for example, a demodulator component, shown as DEMOD, of a modem 232), may be detected by the MIMO detector 236 (for example, a receive (Rx) MIMO processor) if applicable, and/or may be further processed by the receive processor 238 to obtain decoded data and/or control information. The receive processor 238 may provide the decoded data to a data sink 239 (which may be a data pipeline, a data queue, and/or another type of data sink) and provide the decoded control information to a processor, such as the controller/processor 240.

The network node 110 may use the scheduler 246 to schedule one or more UEs 120 for downlink or uplink communications. In some aspects, the scheduler 246 may use DCI to dynamically schedule DL transmissions to the UE 120 and/or UL transmissions from the UE 120. In some examples, the scheduler 246 may allocate recurring time domain resources and/or frequency domain resources that the UE 120 may use to transmit and/or receive communications using an RRC configuration (for example, a semi-static configuration), for example, to perform semi-persistent scheduling (SPS) or to configure a configured grant (CG) for the UE 120.

One or more of the transmit processor 214, the TX MIMO processor 216, the modem 232, the antenna 234, the MIMO detector 236, the receive processor 238, and/or the controller/processor 240 may be included in an RF chain of the network node 110. An RF chain may include one or more filters, mixers, oscillators, amplifiers, analog-to-digital converters (ADCs), and/or other devices that convert between an analog signal (such as for transmission or reception via an air interface) and a digital signal (such as for processing by one or more processors of the network node 110). In some aspects, the RF chain may be or may be included in a transceiver of the network node 110.

In some examples, the network node 110 may use the communication unit 244 to communicate with a core network and/or with other network nodes. The communication unit 244 may support wired and/or wireless communication protocols and/or connections, such as Ethernet, optical fiber, common public radio interface (CPRI), and/or a wired or wireless backhaul, among other examples. The network node 110 may use the communication unit 244 to transmit and/or receive data associated with the UE 120 or to perform network control signaling, among other examples. The communication unit 244 may include a transceiver and/or an interface, such as a network interface.

The UE 120 may include a set of antennas 252 (shown as antennas 252a through 252r, where r≥1), a set of modems 254 (shown as modems 254a through 254u, where u≥1), a MIMO detector 256, a receive processor 258, a data sink 260, a data source 262, a transmit processor 264, a TX MIMO processor 266, a controller/processor 280, a memory 282, and/or a communication manager 140, among other examples. One or more of the components of the UE 120 may be included in a housing 284. In some aspects, one or a combination of the antenna(s) 252, the modem(s) 254, the MIMO detector 256, the receive processor 258, the transmit processor 264, or the TX MIMO processor 266 may be included in a transceiver that is included in the UE 120. The transceiver may be under control of and used by one or more processors, such as the controller/processor 280, and in some aspects in conjunction with processor-readable code stored in the memory 282, to perform aspects of the methods, processes, or operations described herein. In some aspects, the UE 120 may include another interface, another communication component, and/or another component that facilitates communication with the network node 110 and/or another UE 120.

For downlink communication from the network node 110 to the UE 120, the set of antennas 252 may receive the downlink communications or signals from the network node 110 and may provide a set of received downlink signals (for example, R received signals) to the set of modems 254. For example, each received signal may be provided to a respective demodulator component (shown as DEMOD) of a modem 254. Each modem 254 may use the respective demodulator component to condition (for example, filter, amplify, downconvert, and/or digitize) a received signal to obtain input samples. Each modem 254 may use the respective demodulator component to further demodulate or process the input samples (for example, for OFDM) to obtain received symbols. The MIMO detector 256 may obtain received symbols from the set of modems 254, may perform MIMO detection on the received symbols if applicable, and may provide detected symbols. The receive processor 258 may process (for example, decode) the detected symbols, may provide decoded data for the UE 120 to the data sink 260 (which may include a data pipeline, a data queue, and/or an application executed on the UE 120), and may provide decoded control information and system information to the controller/processor 280.

For uplink communication from the UE 120 to the network node 110, the transmit processor 264 may receive and process data (“uplink data”) from a data source 262 (such as a data pipeline, a data queue, and/or an application executed on the UE 120) and control information from the controller/processor 280. The control information may include one or more parameters, feedback, one or more signal measurements, and/or other types of control information. In some aspects, the receive processor 258 and/or the controller/processor 280 may determine, for a received signal (such as received from the network node 110 or another UE), one or more parameters relating to transmission of the uplink communication. The one or more parameters may include a reference signal received power (RSRP) parameter, a received signal strength indicator (RSSI) parameter, a reference signal received quality (RSRQ) parameter, a CQI parameter, or a transmit power control (TPC) parameter, among other examples. The control information may include an indication of the RSRP parameter, the RSSI parameter, the RSRQ parameter, the CQI parameter, the TPC parameter, and/or another parameter. The control information may facilitate parameter selection and/or scheduling for the UE 120 by the network node 110.

The transmit processor 264 may generate reference symbols for one or more reference signals, such as an uplink DMRS, an uplink sounding reference signal (SRS), and/or another type of reference signal. The symbols from the transmit processor 264 may be precoded by the TX MIMO processor 266, if applicable, and further processed by the set of modems 254 (for example, for DFT-s-OFDM or CP-OFDM). The TX MIMO processor 266 may perform spatial processing (for example, precoding) on the data symbols, the control symbols, the overhead symbols, and/or the reference symbols, if applicable, and may provide a set of output symbol streams (for example, U output symbol streams) to the set of modems 254. For example, each output symbol stream may be provided to a respective modulator component (shown as MOD) of a modem 254. Each modem 254 may use the respective modulator component to process (for example, to modulate) a respective output symbol stream (for example, for OFDM) to obtain an output sample stream. Each modem 254 may further use the respective modulator component to process (for example, convert to analog, amplify, filter, and/or upconvert) the output sample stream to obtain an uplink signal.

The modems 254a through 254u may transmit a set of uplink signals (for example, R uplink signals or U uplink symbols) via the corresponding set of antennas 252. An uplink signal may include a UCI communication, a MAC-CE communication, an RRC communication, or another type of uplink communication. Uplink signals may be transmitted on a PUSCH, a PUCCH, and/or another type of uplink channel. An uplink signal may carry one or more TBs of data. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

One or more antennas of the set of antennas 252 or the set of antennas 234 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 2. As used herein, “antenna” can refer to one or more antennas, one or more antenna panels, one or more antenna groups, one or more sets of antenna elements, or one or more antenna arrays. “Antenna panel” can refer to a group of antennas (such as antenna elements) arranged in an array or panel, which may facilitate beamforming by manipulating parameters of the group of antennas. “Antenna module” may refer to circuitry including one or more antennas, which may also include one or more other components (such as filters, amplifiers, or processors) associated with integrating the antenna module into a wireless communication device.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

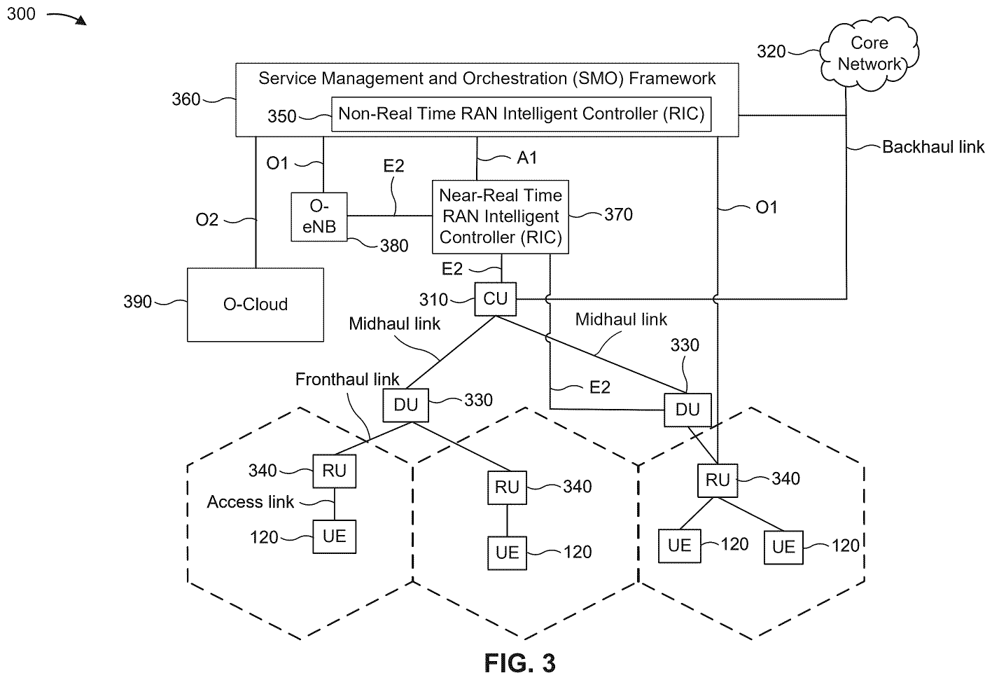

FIG. 3 is a diagram illustrating an example disaggregated base station architecture 300 in accordance with the present disclosure. One or more components of the example disaggregated base station architecture 300 may be, may include, or may be included in one or more network nodes (such one or more network nodes 110). The disaggregated base station architecture 300 may include a CU 310 that can communicate directly with a core network 320 via a backhaul link, or that can communicate indirectly with the core network 320 via one or more disaggregated control units, such as a Non-RT RIC 350 associated with a Service Management and Orchestration (SMO) Framework 360 and/or a Near-RT RIC 370 (for example, via an E2 link). The CU 310 may communicate with one or more DUs 330 via respective midhaul links, such as via F1 interfaces. Each of the DUs 330 may communicate with one or more RUs 340 via respective fronthaul links. Each of the RUs 340 may communicate with one or more UEs 120 via respective RF access links. In some deployments, a UE 120 may be simultaneously served by multiple RUs 340.

Each of the components of the disaggregated base station architecture 300, including the CUs 310, the DUs 330, the RUs 340, the Near-RT RICs 370, the Non-RT RICs 350, and the SMO Framework 360, may include one or more interfaces or may be coupled with one or more interfaces for receiving or transmitting signals, such as data or information, via a wired or wireless transmission medium.

In some aspects, the CU 310 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 310 may be deployed to communicate with one or more DUs 330, as necessary, for network control and signaling. Each DU 330 may correspond to a logical unit that includes one or more base station functions to control the operation of one or more RUs 340. For example, a DU 330 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 330, or for communicating signals with the control functions hosted by the CU 310. Each RU 340 may implement lower layer functionality. In some aspects, real-time and non-real-time aspects of control and user plane communication with the RU(s) 340 may be controlled by the corresponding DU 330.

The SMO Framework 360 may support RAN deployment and provisioning of non-virtualized and virtualized network elements. For non-virtualized network elements, the SMO Framework 360 may support the deployment of dedicated physical resources for RAN coverage requirements, which may be managed via an operations and maintenance interface, such as an O1 interface. For virtualized network elements, the SMO Framework 360 may interact with a cloud computing platform (such as an open cloud (O-Cloud) platform 390) to perform network element life cycle management (such as to instantiate virtualized network elements) via a cloud computing platform interface, such as an O2 interface. A virtualized network element may include, but is not limited to, a CU 310, a DU 330, an RU 340, a non-RT RIC 350, and/or a Near-RT RIC 370. In some aspects, the SMO Framework 360 may communicate with a hardware aspect of a 4G RAN, a 5G NR RAN, and/or a 6G RAN, such as an open eNB (O-NB) 380, via an O1 interface. Additionally or alternatively, the SMO Framework 360 may communicate directly with each of one or more RUs 340 via a respective O1 interface. In some deployments, this configuration can enable each DU 330 and the CU 310 to be implemented in a cloud-based RAN architecture, such as a vRAN architecture.

The Non-RT RIC 350 may include or may implement a logical function that enables non-real-time control and optimization of RAN elements and resources, AI/ML workflows including model training and updates, and/or policy-based guidance of applications and/or features in the Near-RT RIC 370. The Non-RT RIC 350 may be coupled to or may communicate with (such as via an A1 interface) the Near-RT RIC 370. The Near-RT RIC 370 may include or may implement a logical function that enables near-real-time control and optimization of RAN elements and resources via data collection and actions via an interface (such as via an E2 interface) connecting one or more CUs 310, one or more DUs 330, and/or an O-eNB with the Near-RT RIC 370.

In some aspects, to generate AI/ML models to be deployed in the Near-RT RIC 370, the Non-RT RIC 350 may receive parameters or external enrichment information from external servers. Such information may be utilized by the Near-RT RIC 370 and may be received at the SMO Framework 360 or the Non-RT RIC 350 from non-network data sources or from network functions. In some examples, the Non-RT RIC 350 or the Near-RT RIC 370 may tune RAN behavior or performance. For example, the Non-RT RIC 350 may monitor long-term trends and patterns for performance and may employ AI/ML models to perform corrective actions via the SMO Framework 360 (such as reconfiguration via an O1 interface) or via creation of RAN management policies (such as A1 interface policies).

As indicated above, FIG. 3 is provided as an example. Other examples may differ from what is described with regard to FIG. 3.

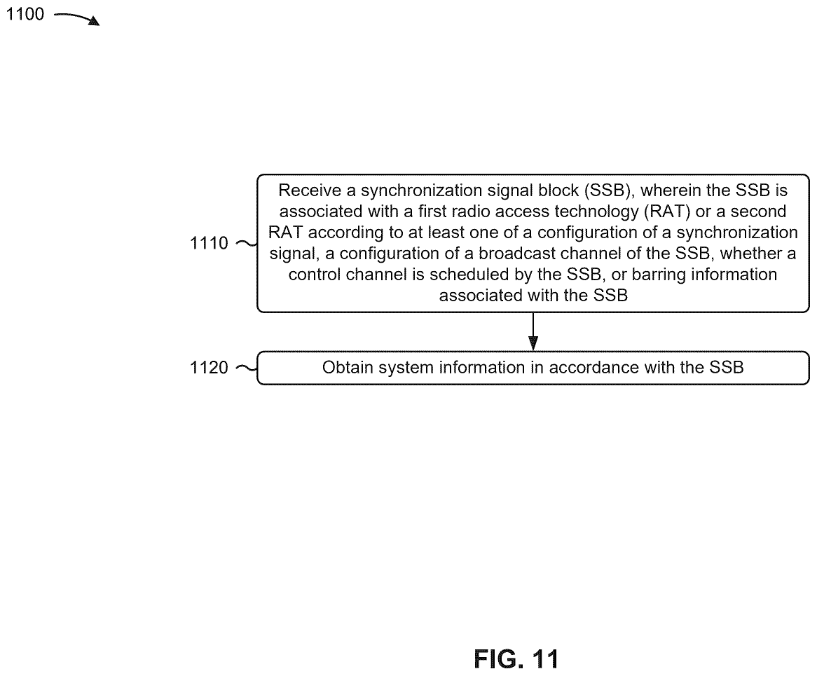

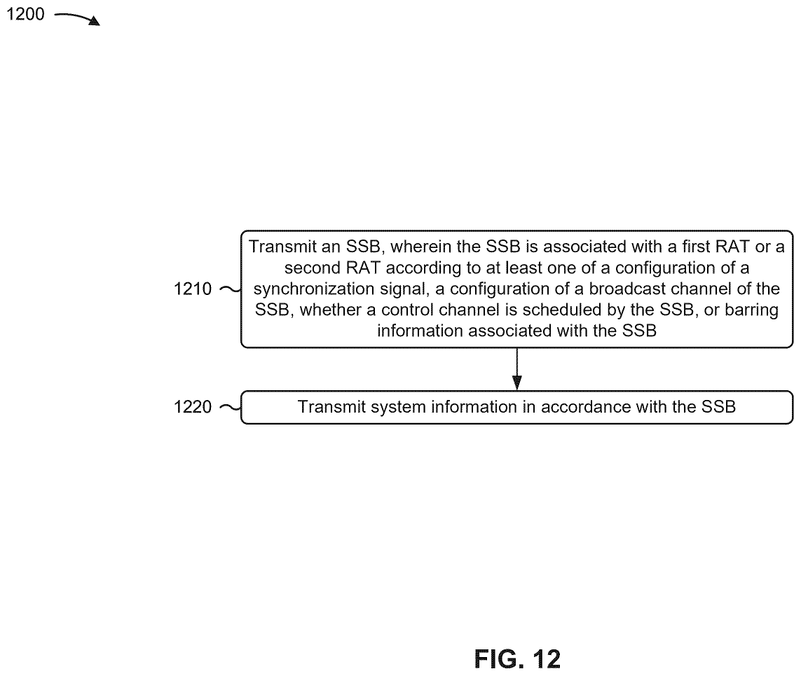

The network node 110, the controller/processor 240 of the network node 110, the UE 120, the controller/processor 280 of the UE 120, the CU 310, the DU 330, the RU 340, or any other component(s) of FIG. 1, 2, or 3 may implement one or more techniques or perform one or more operations associated with SSBs for multiple RATs, as described in more detail elsewhere herein. For example, the controller/processor 240 of the network node 110, the controller/processor 280 of the UE 120, any other component(s) of FIG. 2, the CU 310, the DU 330, or the RU 340 may perform or direct operations of, for example, process 1100 of FIG. 11, process 1200 of FIG. 12, or other processes as described herein (alone or in conjunction with one or more other processors). The memory 242 may store data and program codes for the network node 110, the network node 110, the CU 310, the DU 330, or the RU 340. The memory 282 may store data and program codes for the UE 120. In some examples, the memory 242 or the memory 282 may include a non-transitory computer-readable medium storing a set of instructions (for example, code or program code) for wireless communication. The memory 242 may include one or more memories, such as a single memory or multiple different memories (of the same type or of different types). The memory 282 may include one or more memories, such as a single memory or multiple different memories (of the same type or of different types). For example, the set of instructions, when executed (for example, directly, or after compiling, converting, or interpreting) by one or more processors of the network node 110, the UE 120, the CU 310, the DU 330, or the RU 340, may cause the one or more processors to perform process 1100 of FIG. 11, process 1200 of FIG. 12, or other processes as described herein. In some examples, executing instructions may include running the instructions, converting the instructions, compiling the instructions, and/or interpreting the instructions, among other examples.

In some aspects, the UE 120 includes means for receiving an SSB, wherein the SSB is associated with a first RAT or a second RAT according to at least one of: a configuration of a synchronization signal, a configuration of a broadcast channel of the SSB, whether a control channel is scheduled by the SSB, or barring information associated with the SSB; and/or means for obtaining system information in accordance with the SSB. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for transmitting an SSB, wherein the SSB is associated with a first RAT or a second RAT according to at least one of: a configuration of a synchronization signal, a configuration of a broadcast channel of the SSB, whether a control channel is scheduled by the SSB, or barring information associated with the SSB; and/or means for transmitting system information in accordance with the SSB. The means for the network node 110 to perform operations described herein may include, for example, one or more of communication manager 150, transmit processor 214, TX MIMO processor 216, modem 232, antenna 234, MIMO detector 236, receive processor 238, controller/processor 240, memory 242, or scheduler 246.

As indicated above, FIG. 3 is provided as an example. Other examples may differ from what is described with regard to FIG. 3.

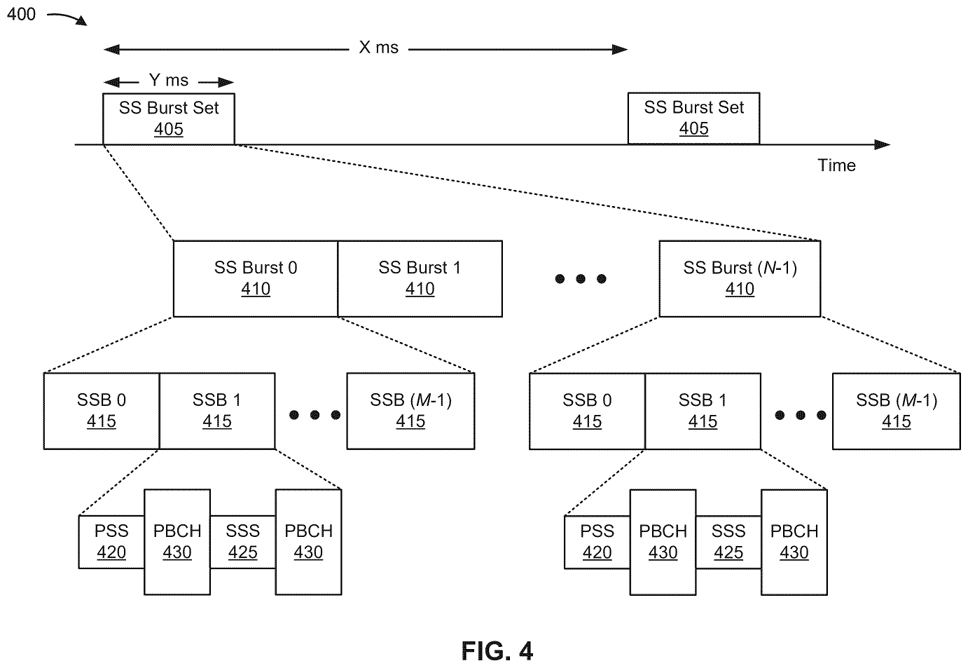

FIG. 4 is a diagram illustrating an example 400 of a synchronization signal (SS) hierarchy, in accordance with the present disclosure. As shown in FIG. 4, the SS hierarchy may include an SS burst set 405, which may include multiple SS bursts 410, shown as SS burst 0 through SS burst N−1, where N is a maximum number of repetitions of the SS burst 410 that may be transmitted by one or more network nodes. As further shown, each SS burst 410 may include one or more SS blocks (SSBs) 415, shown as SSB 0 through SSB M−1, where M is a maximum number of SSBs 415 that can be carried by an SS burst 410. In some aspects, different SSBs 415 may be beam-formed differently (e.g., transmitted using different beams), and may be used for cell search, cell acquisition, beam management, and/or beam selection (e.g., as part of an initial network access procedure). An SS burst set 405 may be periodically transmitted by a wireless node (e.g., a network node 110), such as every X milliseconds, as shown in FIG. 4. In some aspects, an SS burst set 405 may have a fixed or dynamic length, shown as Y milliseconds in FIG. 4. In some cases, an SS burst set 405 or an SS burst 410 may be referred to as a discovery reference signal (DRS) transmission window or an SSB measurement time configuration (SMTC) window.

In some aspects, an SSB 415 may include resources that carry a primary synchronization signal (PSS) 420, a secondary synchronization signal (SSS) 425, and/or a physical broadcast channel (PBCH) 430. In some aspects, multiple SSBs 415 are included in an SS burst 410 (e.g., with transmission on different beams), and the PSS 420, the SSS 425, and/or the PBCH 430 may be the same across each SSB 415 of the SS burst 410. In some aspects, a single SSB 415 may be included in an SS burst 410. In some aspects, the SSB 415 may be at least four symbols (e.g., OFDM symbols) in length, where each symbol carries one or more of the PSS 420 (e.g., occupying one symbol), the SSS 425 (e.g., occupying one symbol), and/or the PBCH 430 (e.g., occupying two symbols), as described elsewhere herein. In some aspects, an SSB 415 may be referred to as an SS/PBCH block.

In some aspects, the symbols of an SSB 415 are consecutive, as shown in FIG. 4. In some aspects, the symbols of an SSB 415 are non-consecutive. Similarly, in some aspects, one or more SSBs 415 of the SS burst 410 may be transmitted in consecutive radio resources (e.g., consecutive symbols) during one or more slots. Additionally, or alternatively, one or more SSBs 415 of the SS burst 410 may be transmitted in non-consecutive radio resources.

In some aspects, the SS bursts 410 may have a burst period, and the SSBs 415 of the SS burst 410 may be transmitted by a wireless node (e.g., a network node 110) according to the burst period. In this case, the SSBs 415 may be repeated during each SS burst 410. In some aspects, the SS burst set 405 may have a burst set periodicity, whereby the SS bursts 410 of the SS burst set 405 are transmitted by the wireless node according to the fixed burst set periodicity. In other words, the SS bursts 410 may be repeated during each SS burst set 405.

In some aspects, an SSB 415 may include an SSB index, which may correspond to a beam used to carry the SSB 415. A UE 120 may monitor for and/or measure SSBs 415 using different receive (Rx) beams during an initial network access procedure and/or a cell search procedure, among other examples. Based at least in part on the monitoring and/or measuring, the UE 120 may indicate one or more SSBs 415 with a best signal parameter (e.g., a reference signal received power (RSRP) parameter) to a network node 110 (e.g., directly or via one or more other network nodes). The network node 110 and the UE 120 may use the one or more indicated SSBs 415 to select one or more beams to be used for communication between the network node 110 and the UE 120 (e.g., for a random access channel (RACH) procedure). Additionally, or alternatively, the UE 120 may use the SSB 415 and/or the SSB index to determine a cell timing for a cell via which the SSB 415 is received (e.g., a serving cell).

As indicated above, FIG. 4 is provided as an example. Other examples may differ from what is described with regard to FIG. 4.

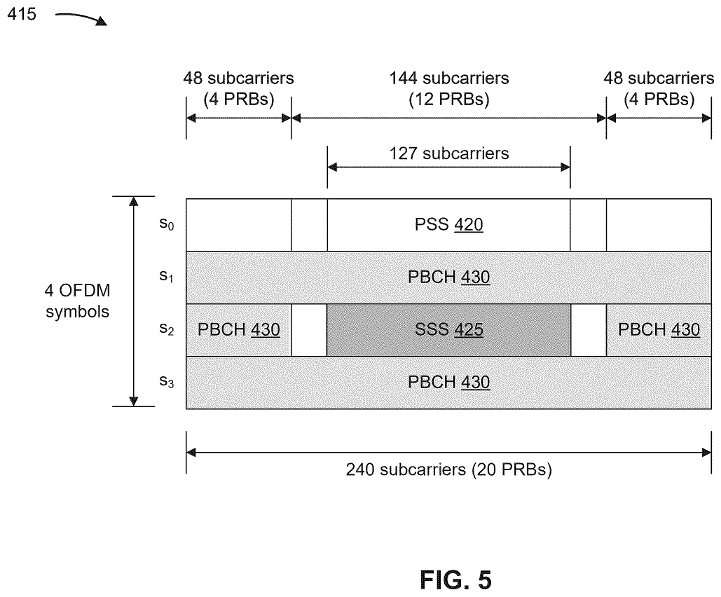

FIG. 5 is a diagram illustrating an example of an SSB configuration for an SSB 415, in accordance with the present disclosure. In some aspects, as described herein, the SSB configuration shown in FIG. 5 corresponds to a time-frequency structure associated with an SSB 415 that a network node 110 periodically broadcasts or otherwise transmits over an access link (e.g., a Uu interface) to enable initial network acquisition and synchronization for a UE 120. Additionally, or alternatively, the SSB configuration shown in FIG. 5 may be used for cell search on an access link, beam management on an access link, and/or beam selection on an access link, among other examples. For example, as shown, the SSB 415 may include a PSS 420, an SSS 425, and a PBCH 430 carrying information that a UE 120 may use to derive, decode, or otherwise obtain necessary information to access a cell provided by the network node 110 (e.g., a radio frame boundary, a physical cell identity, and/or a master information block (MIB) that provides parameters to acquire system information block Type 1 (SIB1), among other examples). Furthermore, in some aspects, the PBCH 430 includes a DMRS (which may be referred to herein as a PBCH DMRS), which carries a pseudo-noise (PN) sequence or other suitable information to enable a UE 120 to perform channel estimation to demodulate or decode the PBCH 430.

In general, as shown in FIG. 5, each SSB 415 transmitted on an access link occupies four (4) consecutive symbols in a time domain (shown as s₀ through s₃) and includes a PSS 420, SSS 425, and PBCH 430 spread over 240 subcarriers in a frequency domain (e.g., 20 RBs that each include 12 subcarriers). As shown in FIG. 5, the PSS 420 occupies the first symbol (so) and spans 127 subcarriers, and the SSS 425 is located in the third symbol (s₂) and spans 127 subcarriers, with 8 unused subcarriers above the SSS 425 and 9 unused subcarriers below the SSS 425. As further shown in FIG. 5, the PBCH 430 occupies two full symbols, spanning 240 subcarriers in the second symbol (s₁) and the fourth symbol (s₃), and the PBCH 430 partially occupies the third symbol (s₂), spanning 48 subcarriers above the SSS 425 and 48 subcarriers below the SSS 425, whereby the PBCH 430 occupies 576 subcarriers across three symbols. Furthermore, the PBCH DMRS occupies three (3) REs in each RB allocated to the PBCH 430, whereby the PBCH DMRS occupies 144 REs across three symbols (e.g., 3 REs in each of 48 RBs allocated to the PBCH) and the remaining 432 REs in the 48 RBs allocated to the PBCH 430 carry the PBCH payload.

As mentioned, in some aspects, a first RAT (e.g., 5G) and a second RAT (e.g., 6G) may both be deployed in a cell, such as using multi-RAT spectrum sharing (MRSS). In some other aspects, a cell may be transitioned from implementing only the first RAT to implementing only the second RAT (referred to as refarming the cell). MRSS can be semi-static or dynamic. From the point of view of a network node 110, in an MRSS cell, two RATs are present, and thus signals (such as SSBs) of the two RATs coexist. In a refarmed cell, the first RAT is absent. Cells in certain spectrum regions may be refarmed or shared via MRSS, such as in a range up to 3 GHZ (which may allow a maximum of 4 beams), a range of 3 GHz to 6 GHz (which may allow up to 8 beams), and/or a range of 6 GHz to 52.6 GHz (which may allow up to 64 beams). In each of these ranges, a full SS burst 410 may be confined within a span of a 5 ms window, and in 5G, an SS burst periodicity (defining a length of time between SS bursts 410) may use a default value of 20 ms. Generally, for 5G, sub-6 GHz bands may use subcarrier spacings (SCSs) of 15 kHz or 30 kHz for the SSB 415, and bands above 6 GHz may use SCSs of 120 kHz or 240 kHz for the SSB 415.

An SSB 415 may be transmitted according to an SSB raster, referred to herein as a synchronization raster. The synchronization raster may be defined by one or more tables, such as one or more tables of a wireless communication specification (such as 3GPP Technical Specification (TS) 38-101.1. An example synchronization raster is provided by the below Tables:

TABLE 1
GSCN parameters for the global frequency
raster for above 3 MHz channel bandwidth

| Frequency | | SS Block frequency | | Range of |
|---|---|---|---|---|
| range | | position SSREF | GSCN | GSCN |
| 0-3000 | MHz | N * 1200 kHz + M * | 3N + (M − | 2-7498 |
| | | 50 kHz, | 3)/2 | |
| | | N = 1:2499, M ∈ | | |
| | | {1, 3, 5} (Note 1) | | |
| 3000-24250 | MHz | 3000 MHz + N * | 7499 + N | 7499-22255 |
| | | 1.44 MHz | | |
| | | N = 0:14756 | | |

(NOTE 1):
The default value for operating bands with which only support SCS spaced channel raster(s) is M = 3.

TABLE 2
Applicable synchronization signal raster entries per
operating band for above 3 MHz channel bandwidth

| | | | Range of GSCN |
|---|---|---|---|
| NR operating | | | (First-<Step |
| band | SS Block SCS | SS Block pattern | size>-Last) |
| n1 | 15 kHz | Case A | 5279-<1>-5419 |
| n2 | 15 kHz | Case A | 4829-<1>-4969 |
| n3 | 15 kHz | Case A | 4517-<1>-4693 |
| n5 | 15 kHz | Case A | 2177-<1>-2230 |
| | 30 kHz | Case B | 2183-<1>-2224 |
| n7 | 15 kHz | Case A | 6554-<1>-6718 |
| n8 | 15 kHz | Case A | 2318-<1>-2395 |
| n12 | 15 kHz | Case A | 1828-<1>-1858 |
| n13 | 15 kHz | Case A | 1871-<1>-1885 |
| n14 | 15 kHz | Case A | 1901-<1>-1915 |
| n18 | 15 kHz | Case A | 2156-<1>-2182 |
| n20 | 15 kHz | Case A | 1982-<1>-2047 |
| n24 | 15 kHz | Case A | 3818-<1>-3892 |
| | 30 kHz | Case B | 3824-<1>-3886 |
| n25 | 15 kHz | Case A | 4829-<1>-4981 |
| n26 | 15 kHz | Case A | 2153-<1>-2230 |
| n28 | 15 kHz | Case A | 1901-<1>-2002 |
| n29 | 15 kHz | Case A | 1798-<1>-1813 |
| n30 | 15 kHz | Case A | 5879-<1>-5893 |
| n31 | 15 kHz | Case A | 1161-<1>-1162 |
| n34 | 15 kHz | Case A | NOTE 5 |
| | 30 kHz | Case C | 5036-<1>-5050 |
| n38 | 15 kHz | Case A | NOTE 2 |
| | 30 kHz | Case C | 6437-<1>-6538 |
| n39 | 15 kHz | Case A | NOTE 6 |
| | 30 kHz | Case C | 4712-<1>-4789 |
| n40 | 30 kHz | Case C | 5762-<1>-5989 |
| n41 | 15 kHz | Case A | 6246-<3>-6717 |
| | 30 kHz | Case C | 6252-<3>-6714 |
| n46 | 30 kHz | Case C | 8993-<1>-9530 |
| n48 | 30 kHz | Case C | 7884-<1>-7982 |
| n50 | 30 kHz | Case C | 3590-<1>-3781 |
| n51 | 15 kHz | Case A | 3572-<1>-3574 |
| n53 | 15 kHz | Case A | 6215-<1>-6232 |
| | 30 kHz | Case C | 6221-<1>-6226 |
| n54 | 15 kHz | Case A | 4181-<1>-4182 |
| n65 | 15 kHz | Case A | 5279-<1>-5494 |
| n66 | 15 kHz | Case A | 5279-<1>-5494 |
| | 30 kHz | Case B | 5285-<1>-5488 |
| n67 | 15 kHz | Case A | 1850-<1>-1888 |
| n70 | 15 kHz | Case A | 4993-<1>-5044 |
| n71 | 15 kHz | Case A | 1547-<1>-1624 |
| n72 | 15 kHz | Case A | 1157-<1>-1159 |
| n74 | 15 kHz | Case A | 3692-<1>-3790 |
| n75 | 15 kHz | Case A | 3584-<1>-3787 |
| n76 | 15 kHz | Case A | 3572-<1>-3574 |
| n77 | 30 kHz | Case C | 7711-<1>-8329 |
| n78 | 30 kHz | Case C | 7711-<1>-8051 |
| n79 | 30 kHz | Case C | 8480-<16>-8880 |
| | | | 8475-<1>-8884 |
| n85 | 15 kHz | Case A | 1826-<1>-1858 |
| n90 | 15 kHz | Case A | 6246-<1>-6717 |
| | | | 6245-<1>-6718 |
| | 30 kHz | Case C | 6252-<1>-6714 |
| n91 | 15 kHz | Case A | 3572-<1>-3574 |
| n92 | 15 kHz | Case A | 3584-<1>-3787 |
| n93 | 15 kHz | Case A | 3572-<1>-3574 |
| n94 | 15 kHz | Case A | 3584-<1>-3787 |
| n96 | 30 kHz | Case C | 9531-<1>-10363 |
| n100 | 15 kHz | Case A | 2303-<1>-2307, |
| | | | 41638 |
| n101 | 15 kHz | Case A | 4754-<1>-4768 |
| | 30 kHz | Case C | 4760-<1>-4764 |
| n102 | 30 kHz | Case C | 9531-<1>-9877 |
| n104 | 30 kHz | Case C | 9882-<7>-10358 |
| n105 | 15 kHz | Case A | 1535-<1>-1624 |
| n109 | 15 kHz | Case A | 3584-<1>-3787 |

The SS block patterns of Table 2 indicate symbols used for different SSB indexes within a burst. “NOTE 5” indicates that the applicable SS raster entries are global synchronization channel number (GSCN)={5032, 5043, 5054}. “NOTE 2” indicates that the applicable SS raster entries are GSCN={6432, 6443, 6457, 6468, 6479, 6493, 6507, 6518, 6532, 6543}. “NOTE 6” indicates that the applicable SS raster entries are GSCN={4707, 4715, 4718, 4729, 4732, 4743, 4747, 4754, 4761, 4768, 4772, 4782, 4786, 4793}. Similar tables are defined for bands between 24 GHz and 100 GHz (such as NR operating bands n257, n258, n259, n260, n261, n262, and n263) in 3GPP TS 38.101-2:

TABLE 3
GSCN parameters for the global frequency raster

| Frequency | SS block frequency | | Range of |
|---|---|---|---|
| range | position SS_{REF} | GSCN | GSCN |
| 24250-100000 MHz | 24250.08 MHz + N * | 22256 + N | 22256-26639 |
| | 17.28 MHz, | | |
| | N = 0:4383 | | |

TABLE 4
Applicable SS raster entries per operating band

| | | | Range of GSCN |
|---|---|---|---|
| NR Operating | | | (First-<Step |
| Band | SS Block SCS | SS Block pattern¹ | size>-Last) |
| n257 | 120 kHz | Case D | 22388-<1>-22558 |
| | 240 kHz | Case E | 22390-<2>-22556 |
| n258 | 120 kHz | Case D | 22257-<1>-22443 |
| | 240 kHz | Case E | 22258-<2>-22442 |
| n259 | 120 kHz | Case D | 23140-<1>-23369 |
| | 240 kHz | Case E | 23142-<2>-23368 |
| n260 | 120 kHz | Case D | 22995-<1>-23166 |
| | 240 kHz | Case E | 22996-<2>-23164 |
| n261 | 120 kHz | Case D | 22446-<1>-22492 |
| | 240 kHz | Case E | 22446-<2>-22490 |
| n262 | 120 kHz | Case D | 23586-<1>-23641 |
| | 240 kHz | Case E | 23588-<2>-23640 |
| n263 | 120 kHz | Case D | Table 5 |
| | 480 kHz | Case F | |
| | 960 kHz² | Case G | 24162-<6>-24954 |

NOTE 1:
SS Block pattern is defined in clause 4.1 in TS 38.213.
NOTE 2:
SS Block SCS of 960 kHz is not used for initial access.

TABLE 5
Allowed GSCN for operation in band
n263 for 120 kHz and 480 kHz

| SS Block | |
|---|---|
| SCS | Range of GSCN |
| 120 kHz | 24156 + 6 * N − 3 * floor((N + 5)/18), N = 0:137 |
| 480 kHz | 24162 + 24 * N − 12 * floor((N + 4)/18), N = 0:33 |

TABLE 6
SSB block pattern

| Case/ | Freq | | | |
|---|---|---|---|---|
| SCS | range | Starting symbol | List of 1^{st} symbols | Comments |
| Case | <=3 GHz | {2, 8} + 14.n, | {2, 8, 16, 22} | 2-sym gap across SSBs |
| A/15 kHz | (w/o SSCA) | n = 0, 1 | | |
| Case | >3 GHz, | {2, 8} + 14.n, | {2, 8, 16, 20, 32, 36, | 2-sym gap across SSBs |
| A/15 kHz | FR1 | n = 0, 1, 2, 3 | 44, 48} | |
| Case | w/SSCA | {2, 8} + 14.n, | {2, 8, 16, 20, 32, 36, | 2-sym gap across SSBs |
| A/15 kHz | | n = 0, 1, 2, 3, 4 | 44, 48, 58, 64} | |
| Case | <=3 GHz | {4, 8, 16, 20} + | {4, 8, 16, 20} | No sym gap across SSBs |
| B/30 kHz | | 28.n, n = 0 | | |
| Case | >3 GHz, | {4, 8, 16, 20} + | {4, 8, 16, 20, 32, | No sym gap across SSBs |
| B/30 kHz | FR1 | 28.n, n = 0, 1 | 36, 44, 48} | |
| Case | w/o SSCA, | {2, 8} + 14.n, | {2, 8, 16, 22} | 2-sym gap across SSBs |
| C/30 kHz | FDD, <=3 GHz | n = 0, 1 | | |
| Case | w/o SSCA, | {2, 8} + 14.n, | {2, 8, 16, 20, 32, 36, | 2-sym gap across SSBs |
| C/30 kHz | FDD, >3 GHz, | n = 0, 1, 2, 3 | 44, 48} | |
| | FR1 | | | |
| Case | w/o SSCA, | {2, 8} + 14.n, | {2, 8, 16, 22} | 2-sym gap across SSBs |
| C/30 kHz | TDD, <= 1.88 GHz | n = 0, 1 | | |
| Case | w/o SSCA, | {2, 8} + 14.n, | {2, 8, 16, 20, 32, 36, | 2-sym gap across SSBs |
| C/30 kHz | TDD, >1.88 GHz, | n = 0, 1, 2, 3 | 44, 48} | |
| | FR1 | | | |
| Case | w/ SSCA | {2, 8} + 14.n, | {2, 8, 16, 20, 32, 36, | 2-sym gap across SSBs |
| C/30 kHz | | n = 0, 1, 2, 3, 4, 5, 6, | 44, 48, 58, 64, | |
| | | 7, 8, 9 | 72, 78, . . .} | |
| Case | FR2 | {4, 8, 16, 20} + | {4, 8, 16, 20, 32, 36, | No sym gap across SSBs |
| D/120 kHz | | 28.n, n = 0, | 44, 48, . . . 508 | |
| | | 1, . . . 18 | 512, 520, 524} | |
| Case | FR2 | {8, 12, 16, 20, 32, | {8, 12, 16, 20, . . ., | No sym gap across SSBs |
| E/240 kHz | | 36, 40, 44} + | 480, 484, 488, 492} | |
| | | 56.n, n = | | |
| | | {0, 1, 2, 3, 5, 6, 7, 8} | | |
| Case | FR2-2 | {2, 9} + 14.n, | {2, 9, 16, 23, . . ., | 3-sym gap across SSBs |
| F/480 kHz | | n = 0, 1, . . . 31 | 436, 443} | |
| Case | FR2-2 | {2, 8} + 14.n, | {2, 9, 16, 23, . . ., | 3-sym gap across SSBs |
| G/960 kHz | | n = 0, 1, . . . , 31 | 436, 443} | |

As described herein, a reference to a 5G synchronization raster or a synchronization raster for a first RAT may refer to a synchronization raster defined by Tables 1, 2, 3, 4, 5, and/or 6. In some examples described herein, a 6G synchronization raster (or a synchronization raster for a second RAT) may also be defined according to Tables 1, 2, 3, 4, 5, and/or 6. Additionally, or alternatively, the 5G synchronization raster may be modified (such as according to a time offset, a frequency offset, or the like) to define the 6G synchronization raster. For example, the 5G synchronization raster may be modified such that one or more new raster points are defined for the 6G synchronization raster. Additionally, or alternatively, a subset (such as a proper subset) of 5G synchronization raster points may be used in the 6G synchronization raster. As another example, the 5G synchronization raster and the 6G synchronization raster may be a same synchronization raster, and a time configuration of an SSB (such as whether or not the SSB is transmitted with a time offset relative to the synchronization raster) may indicate whether the SSB is associated with the first RAT or the second RAT. For example, the time configuration may indicate whether the SSB is transmitted at a time indicated by the synchronization raster, or at a time defined by a time offset relative to the synchronization raster.

The PBCH 430 may carry a master information block (MIB). A MIB may provide information regarding a system bandwidth, a system frame number, or the like. References herein to information included in a PBCH 430 can refer to information within the PBCH 430 and outside of the MIB and/or information within the MIB. Table 7, below, indicates information that is provided in the PBCH 430, and indicates whether this information is provided in the MIB or in the PBCH 430 and outside of the MIB:

TABLE 7
PBCH contents

| | Number of Bits | | | |
|---|---|---|---|---|
| | | | | Carried by PBCH |
| | | | Carried by | (excluding MIB |
| Information/field | Total | | MIB | contents) |
| System Frame Number | 10 | | 6 | 4 |
| (SFN) | | | | |
| Sub Carrier Spacing (for | 1 | | 1 | 0 |
| SIB1, Initial access Msg-2/4, | | | | |
| paging, SI-messages) | | | | |
| SSB Subcarrier Offset | FR1 | 5 | 4 | 1 |
| | FR2 | 4 | | 0 |
| dmrs-TypeA-Position | 1 | | 1 | 0 |
| PDCCH Config for SIB1 | 8 | | 8 | 0 |
| Cell Barring Information flag | 1 | | 1 | 0 |
| Intra-Frequency Reselection | 1 | | 1 | 0 |
| allowed/not allowed flag | | | | |
| SSB Index | FR1 | 0 | 0 | 0* |
| | FR2 | 3 | | 3* |
| half-frame bit | 1 | | 0 | 1 |
| Spare bits | 1 | | 1 | 0 |
| Reserved bits | FR1 | 2 | 0 | 2 |
| | FR2 | 0 | | 0 |
| BCCH-BCH-MessageType | 1 | | 1 | 0 |
| indication | | | | |

| | | | |
|---|---|---|---|
| CRC bits | 24 | 0 | 24 |
| Total Number of bits | 56 (FR1 or FR2) | 24 | 32 (FR1 or FR2) |

As indicated above, FIG. 5 is provided as an example. Other examples may differ from what is described with regard to FIG. 5.

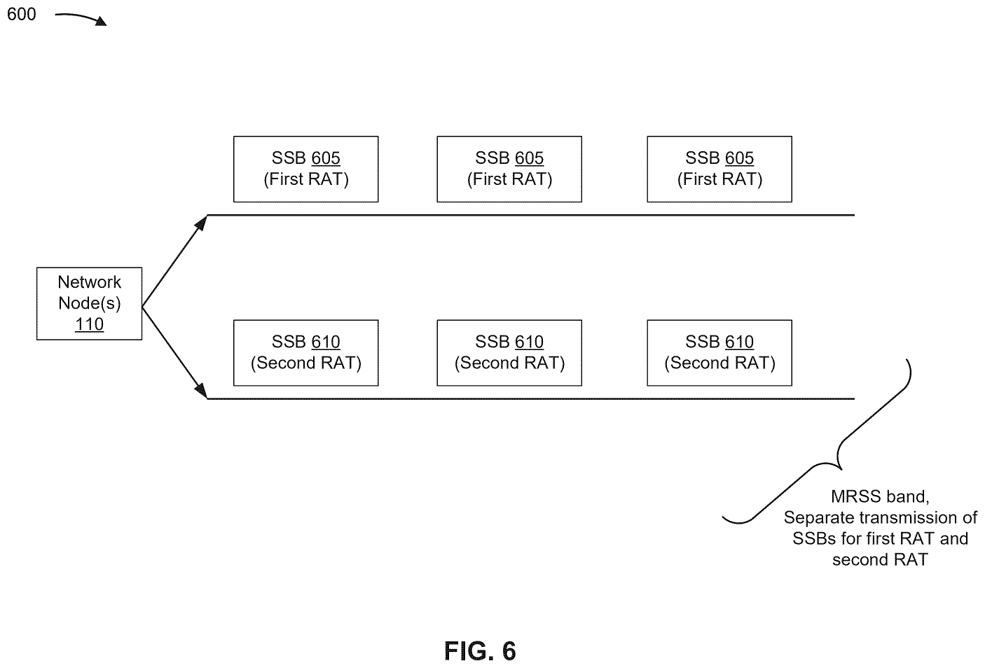

FIG. 6 is a diagram illustrating an example 600 of SSB transmission in an MRSS band, in accordance with the present disclosure. In example 600, SSBs associated with two RATs are transmitted separately.

In some examples, the SSBs are transmitted using different synchronization rasters. For example, a synchronization raster for the first RAT may be based on the synchronization raster defined by Tables 1 through 6, and a synchronization raster for the second RAT may be defined by a frequency offset relative to the synchronization raster for the first RAT. In some aspects, the frequency offset may be based at least in part on a band of the first RAT or the second RAT. For example, a synchronization raster for the second RAT may be defined by a frequency offset, where the frequency offset is associated with a band in which GSCN points (sometimes referred to herein as synchronization raster points) of the synchronization raster for the second RAT occur. In some examples, the SSBs are transmitted using a same synchronization raster. For example, a first set of GSCN points of the synchronization raster (e.g., the synchronization raster defined by Tables 1 through 6) may be used for the first RAT, and a second set of GSCN points of the synchronization raster, different than the first set of GSCN points, may be used for the first RAT. Using the same synchronization raster or different synchronization rasters may be expected to increase a minimum channel bandwidth of the second RAT in MRSS bands due to the increased number of synchronization raster points in MRSS bands.

In some examples, SSBs 605 associated with the first RAT and SSBs 610 associated with the second RAT may be transmitted at a time offset from one another. For example, time-domain resource management (that is, transmitting SSBs of different RATs with a time offset relative to one another) may allow for a minimum channel bandwidth to remain at 5 MHZ.

As shown, one or more network nodes 110 may transmit SSBs 605 and SSBs 610. The SSBs 605 may be associated with a first RAT. For example, the SSBs 605 may use a configuration that is compatible with or defined by the first RAT. The SSBs 610 may be associated with a second RAT that is different than the first RAT. For example, the SSBs 610 may use a configuration that is compatible with or defined by the second RAT. In some aspects, the first RAT may be a first-generation-based RAT and the second RAT may be a second-generation-based RAT. For example, the first-generation-based RAT may be a 5G RAT and the second-generation-based RAT may be a 6G RAT. The SSBs 605 and 610 illustrated in FIG. 6 may be in an MRSS band. Cells in an MRSS band may be co-located and synchronized with one another. Thus, the SSBs 605 may be transmitted by a first network node 110 and the SSBs 610 may be transmitted by a second network node 110, or the SSBs 605 and the SSBs 610 may be transmitted by a same network node 110. If a PSS design and an SSS design are shared between the SSBs 605 and the SSBs 610, a same cell identifier may be used for a 5G cell and a 6G cell in the MRSS band. Sharing at least part of an SSB design between the first RAT and the second RAT in an MRSS band may reduce overhead relative to having separate SSB designs for the first RAT and the second RAT in the MRSS band.

In some examples, at least part of an SSB design may be shared between the first RAT and the second RAT. For example, the SSBs 605 and the SSBs 610 may use the same PSS, the same SSS, the same PBCH configuration (referring to the same resource configuration, encoding, or the like, and different from the PBCH content), or a combination thereof. In such examples, if a same synchronization raster is used for the first RAT and the second RAT, a UE 120 that supports the second RAT may scan for SSBs using two hypotheses: one hypothesis corresponding to the first RAT and another hypothesis corresponding to the second RAT. In such examples, if a same synchronization raster is used for the first RAT and the second RAT, a UE that supports the first RAT may scan for SSBs using the hypothesis corresponding to the first RAT. If the first RAT uses a first synchronization raster and the second RAT uses a second synchronization raster different than the first synchronization raster, the first UE may scan for SSBs 605 using the first synchronization raster (and a single hypothesis corresponding to an SSB design of the first RAT) and the second UE may scan for SSBs 610 using the second synchronization raster (and a single hypothesis corresponding to an SSB design of the second RAT).

In some other examples, the SSBs 610 may differ from the SSBs 605 in a fashion that leads to UEs supporting the first RAT being unable to detect the SSBs 610. For example, the SSBs 610 may be understandable only to UEs that support the second RAT. An SSB 610 that is supported only by UEs that support the second RAT may differ from an SSB 605 with regard to one or more of SSB channelization (such as a number or location of RBs occupied by the SSB 610 or a number or location of symbols occupied by the SSB 610), resources for the PSS (such as a number or location of RBs occupied by the PSS or a number or location of symbols occupied by the PSS), resources for the SSS (such as a number or location of RBs occupied by the SSS or a number or location of symbols occupied by the SSS), resources for the PBCH (such as a number or location of RBs occupied by the PBCH or a number or location of symbols occupied by the PBCH), resources for the DMRS (such as a number or location of REs occupied by the DMRS or a number or location of symbols occupied by the DMRS), a sequence used to generate the PSS, a sequence used to generate the SSS, an encoding scheme of the PBCH, a size of the PBCH, content of the PBCH, a sequence used to generate the DMRS, a scrambling sequence used to generate the PBCH, or a combination thereof. The differences between the SSB 605 and the SSB 610 may mean that only UEs that support the second RAT, and not UEs that support the first RAT, can detect the SSB 610. For example, a UE that supports the first RAT may fail to detect the PSS or the SSS, or may fail to receive the PBCH, such that a valid SSB is not detected by the UE that only supports the first RAT. A sequence may include one or more values used to generate a reference signal. Examples of sequences include Gold sequences and Zadoff-Chu sequences.

As mentioned above, in some examples, the first RAT and the second RAT may use different synchronization rasters. If, for example, the number of GSCN points is doubled (such that the first RAT maintains a current number of GSCN points and an equal number of GSCN points is added for the second RAT), a UE supporting the second RAT may monitor approximately twice as many frequencies as a UE supporting the first RAT. With the same number of PSS hypotheses (each hypothesis comprising a time, a frequency, and a PSS sequence) and the same PSS periodicity, the PSS detection per GSCN point is the same. Also, if the number of DMRS hypotheses and frequency error resolution for the PBCH is the same for the second RAT as for the first RAT, the load of SSS and PBCH detection and decoding per GSCN point is the same for the second RAT as for the first RAT. Hence, it is expected that the UE load increases by a factor of 2 in this scenario (where this scaling is due to monitoring more raster points in the frequency domain).

As also mentioned above, in some examples, the first RAT and the second RAT may use a same synchronization raster. If the same synchronization raster is used, the load associated with searching for SSBs by a UE supporting the second RAT may depend on which channels or signals of the SSB (if any) are shared between the first RAT and the second RAT. If no channels or signals are shared (that is, with a completely different design), the load for the UE supporting the second RAT is twice the load of a UE supporting only the first RAT (since 2 sets of hypotheses may be used to search at each GSCN point). One set of samples may be processed or pre-processed for shared blocks (that is, shared processing blocks that can process signals/channels of the first RAT and signals/channels of the second RAT) at the UE supporting the second RAT, and narrowband filters for the first RAT may be reused for the second RAT. If one or more channels or signals are shared between SSBs of the first RAT and SSBs of the second RAT, complexity at the UE supporting the second RAT may be reduced. In some aspects, adopting the same synchronization raster, even with a new SSB design for the second RAT, may benefit a UE, as compared to defining a new synchronization raster for the second RAT, for the reasons described above and because a smaller number of GSCN points in the frequency domain may lead to less radio frequency (RF) retuning.

As indicated above, FIG. 6 is provided as an example. Other examples may differ from what is described with regard to FIG. 6.

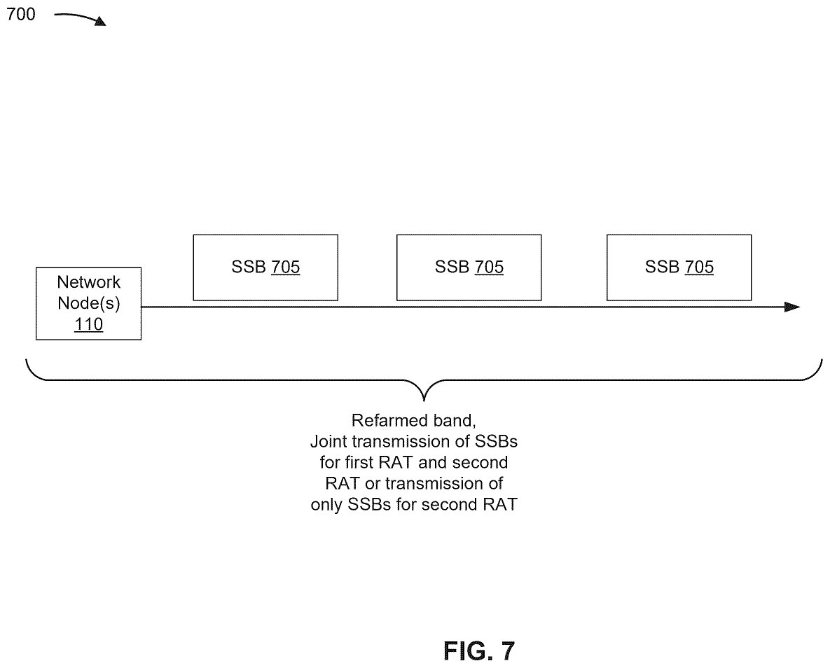

FIG. 7 is a diagram illustrating an example 700 of a band or cell in which only the second RAT is supported, in accordance with the present disclosure. For example, the band or cell of example 700 may be a refarmed band or cell. As mentioned, a refarmed band (or cell) is a band (or cell) in which only a single RAT is deployed. For example, a refarmed band (or cell) may transition from a first RAT (such as a first-generation-based RAT such as 5G) to a second RAT (such as a second-generation-based RAT such as 6G). Thus, UEs supporting the first RAT may continue to scan for SSBs associated with the first RAT on the refarmed band. Techniques described herein provide differentiation of whether an SSB is associated with the first RAT or the second RAT, which may be beneficial in the refarmed band or cell.

As shown, a network node 110 may transmit only SSBs 705 for the second RAT in a refarmed band (or cell). In some aspects described herein, the SSB 705 may be readable by a UE supporting the first RAT and a UE supporting the second RAT. For example, the SSB 705 may use a same PSS, a same SSS, and a same PBCH configuration, and in some aspects may use content of the PBCH to indicate that the SSB 705 is associated with the second RAT. For example, a UE supporting the first RAT may search for an SSB on a channel that is used for the second RAT. The UE supporting the first RAT may decode an SSB 705 (which is targeted for UEs supporting the second RAT). This SSB 705 may configure a control resource set 0 (CORESET0). The CORESET0 may be for the second RAT, but may be understandable by the UEs supporting the first RAT. Hence, the CORESET0 configuration of the UE supporting the first RAT and the UE supporting the second RAT may be compatible.

In such an example, in some aspects, the UE supporting the first RAT may be barred from accessing a cell associated with the SSB 705, for example, by cell barring information. For example, within the CORESET0, a SIB1 may be scheduled, which may carry barring information intended for UEs supporting the first RAT. For example, the barring information may bar the UE supporting the first RAT from accessing the cell of example 700. In this example, a PDCCH for the first RAT and a PDCCH for the second RAT may have a different design and/or encoding, and a cell of the second RAT (as in example 700) may transmit a SIB1 PDSCH in accordance with a PDSCH design of the first RAT. The SIB1 PDSCH could be the same PDSCH, or could be a separate PDSCH, for the first RAT and for the second RAT. One SIB carrying information for both the first RAT and the second RAT may also improve performance indicators, such as network power, on at least cells supporting the first RAT. This approach may implement barring of earlier-RAT UEs (such as 5G UEs) from accessing a cell of a later RAT (such as 6G), even when the SSB 705 of the later RAT is readable by the earlier-RAT UE, with no complexity increase for the earlier-RAT UE.

As another example, the UE supporting the first RAT may not receive a PDCCH scheduling system information block 1 (SIB1) for UEs of the first RAT. For example, the network node 110 may not transmit the PDCCH for the UE supporting the first RAT.

As yet another example, a cell barring information flag field of a PBCH of the SSB 705 (e.g., a MIB of the PBCH, as described in Table 7) may indicate, to a 5G UE, that the 5G UE is barred from accessing the cell of example 700. In this example, other bits of the PBCH, such as one or more reserved bits, one or more spare bits, or one or more cyclic redundancy check (CRC) bits, may be used to indicate, to a 6G UE, whether the 6G UE is barred from accessing the cell associated with the SSB 705.

In some aspects, SSBs for the second RAT may be transmitted using a time offset relative to SSBs for the first RAT. For example, SSBs for the second RAT in an MRSS band or a refarmed band or cell may be transmitted using a time offset relative to SSBs for the first RAT. In some aspects, SSBs for the first RAT may not be transmitted in a refarmed band or cell. In some aspects, if SSBs for the second RAT use a same PSS and PBCH configuration with a different SSS location or structure than SSBs for the first RAT, a UE supporting the first RAT may find the PSS and not the SSS of the SSB for the second RAT. A UE supporting the second RAT may search for SSBs using two hypotheses per GSCN point: one for the first RAT's SSS location or structure, and another for the second RAT's SSS location or structure. As another example, if SSBs for the second RAT use a same PSS and PBCH configuration with a different SSS sequence than SSBs for the first RAT, a UE supporting the first RAT may find the PSS and not the SSS of the SSB for the second RAT. A UE supporting the second RAT may search for SSBs using two hypotheses per GSCN point: one for the first RAT's SSS sequence, and another for the second RAT's SSS sequence. As another example, if SSBs for the second RAT use a same PSS and SSS configuration with a different PBCH configuration or content than SSBs for the first RAT, a UE supporting the first RAT may find the PSS and the SSS of the SSB for the second RAT, but may fail to decode the PBCH. A UE supporting the second RAT may search for SSBs using two hypotheses per GSCN point: one for the first RAT's PBCH configuration, and another for the second RAT's PBCH configuration. In some aspects, periodicities of the PSS and/or SSS transmissions may be different from one another. For example, a SSS and/or PSS for the first RAT may be transmitted together every Xms, and a periodicity of an SSS and/or PSS for the second RAT may be different than Xms (e.g., the PSS may be transmitted X1 ms, the SSS may be transmitted every X2 ms, and the PBCH may be transmitted every X3 ms, where X1, X2, X3 may all be different, or where two or more of X1, X2, and X3 are equal to one another).

As indicated above, FIG. 7 is provided as an example. Other examples may differ from what is described with regard to FIG. 7.

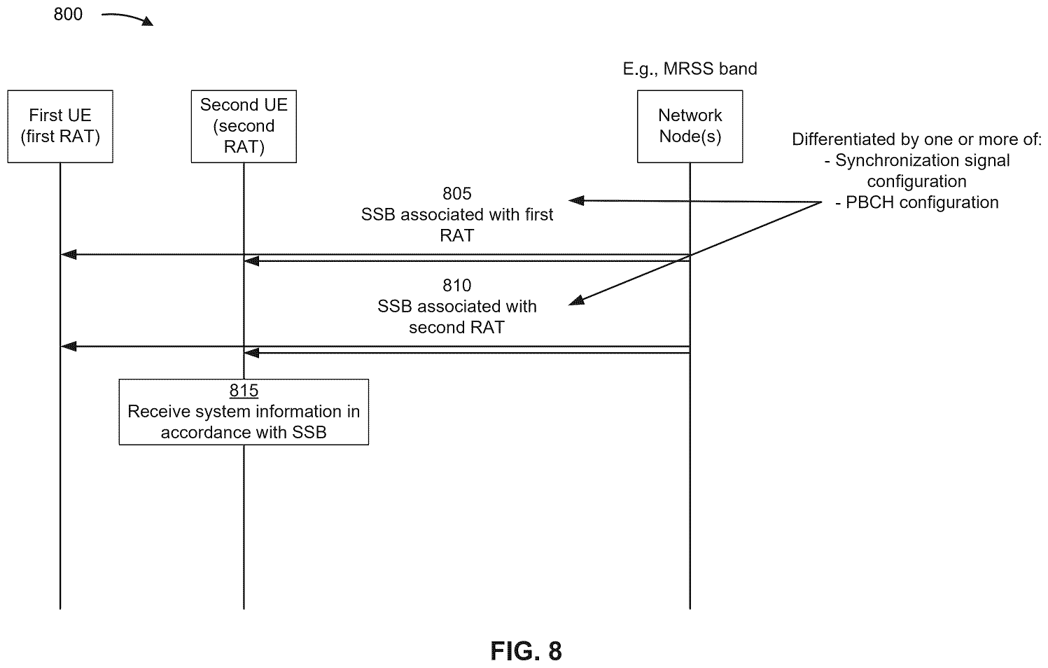

FIG. 8 is a diagram illustrating an example 800 of signaling associated with transmission of separate SSBs for a first RAT and a second RAT, in accordance with the present disclosure. As shown, example 800 includes a first UE (e.g., UE 120) that supports only the first RAT and a second UE (e.g., UE 120) that supports the second RAT (and optionally the first RAT). Example 800 also includes a network node, which may represent one or more network nodes. The network node transmits an SSB 805 that is associated with the first RAT and an SSB 810 associated with the second RAT. Example 800 describes different ways for the SSB 810 to be associated with the second RAT, such that the first UE does not access a cell associated with the SSB 810 (and instead accesses the cell using the SSB 805). Example 800 may relate to an MRSS band. For example, the SSB 805 and the SSB 810 may be transmitted in an MRSS band, as described with regard to FIG. 6.

The SSB 805 may be associated with (e.g., compatible with) the first RAT. For example, the SSB 805 may use a configuration and/or format defined by the first RAT (such as 5G), including a PSS, an SSS, and a PBCH. The first UE may detect the PSS, may correlate the SSS with the PSS, and may identify the PBCH accordingly. The first UE may obtain the PBCH (and the MIB), and may decode SIB1 according to the PBCH.

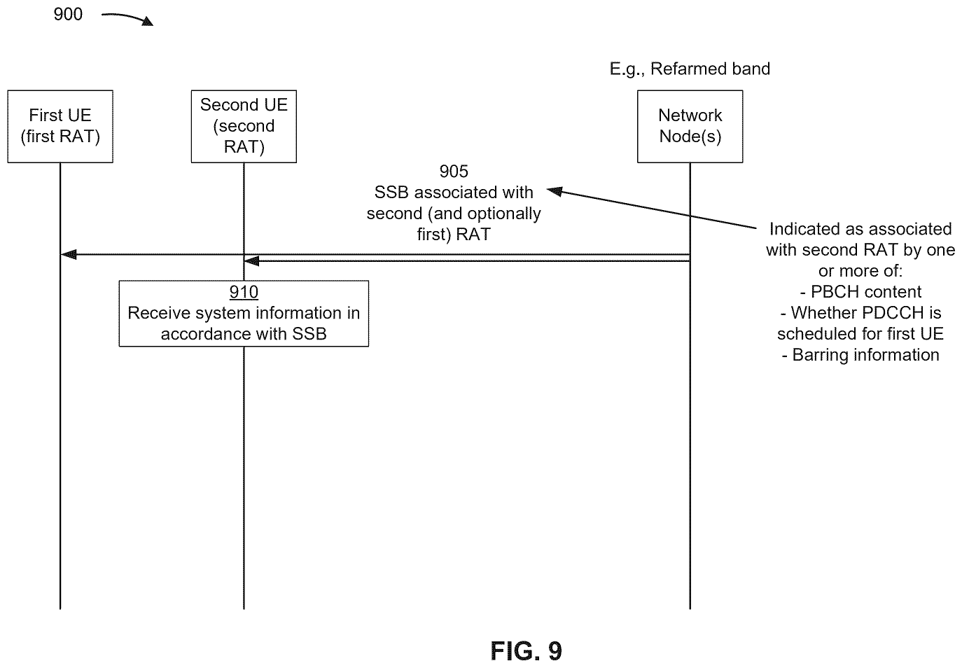

The SSB 810 may differ from the SSB 805 with regard to at least one of a configuration of a synchronization signal (the PSS or the SSS) or a configuration of the PBCH (which is distinct from content of the PBCH, as described elsewhere herein). The configuration of the synchronization signal or the configuration of the PBCH may indicate that the SSB 810 is associated with the second RAT. Examples are provided below. Note that, in other aspects described herein, the SSB 810 is indicated as associated with the second RAT by barring information, content of the PBCH, or whether a control channel for the first RAT is scheduled by the SSB 810. These other aspects are described elsewhere herein. Also, in some other aspects, a single SSB is transmitted for the first RAT and the second RAT, which is described in connection with FIG. 9.

In some aspects, the SSB 810 is associated with the second RAT according to the configuration of the synchronization signal. For example, the configuration of the synchronization signal may be a configuration of the PSS. Examples of how the configuration of the PSS may indicate that the SSB 810 is associated with the second RAT are provided below.

In some aspects, a first sequence for the PSS is associated with the first RAT (that is, the SSB 805 may use the first sequence) and a second sequence for the PSS is associated with the second RAT (that is, the SSB 810 may use the second sequence). In some aspects, a first set of sequences for the PSS may be associated with the first RAT and a second set of sequences for the PSS may be associated with the second RAT. As just one example, the first RAT may be associated with 3 PSS sequences, and the second RAT may be associated with a single PSS sequence. In this example, the configuration of the SSS and the configuration of the PBCH may be the same between the first RAT and the second RAT, and the SSB 805 and the SSB 810 may use a same PSS length. This may be beneficial because PSS narrowband filter hardware and Fast Fourier Transform (FFT) based correlation components can be shared at the second UE. In this example, the first UE may not detect the PSS of the SSB 810, and the second UE may search for the SSB 810 using two hypotheses: one hypothesis with the first sequence and another hypothesis with the second sequence.

In some aspects, the configuration of the synchronization signal is a configuration of the SSS. Examples of how the configuration of the SSS may indicate that the SSB 810 is associated with the second RAT are provided below.

In some aspects, a first sequence for the SSS is associated with the first RAT (that is, the SSB 805 may use the first sequence) and a second sequence for the SSS is associated with the second RAT (that is, the SSB 810 may use the second sequence). In this example, the configuration of the PSS and the configuration of the PBCH may be the same between the first RAT and the second RAT, and the SSB 805 and the SSB 810 may use a same SSS location and structure. This may be beneficial because the entire PSS detection chain can be shared between the first RAT and the second RAT at the second UE, memory or double data rate bandwidth for PSS combining is equivalent to memory or double data rate bandwidth for PSS combining in the first RAT, and SSS pre-processing (such as sample extraction, filtering, and whitening) can be shared between the first RAT and the second RAT. In this example, the first UE may not detect the SSS of the SSB 810, and the second UE may search for the SSB 810 using two hypotheses: one hypothesis with the first sequence and another hypothesis with the second sequence.

In some aspects, a first structure of the SSS is associated with the first RAT (that is, the SSB 805 may use the first structure) and a second structure of the SSS is associated with the second RAT (that is, the SSB 810 may use the second structure). A structure may define a time and/or frequency configuration of an SSB, such as how elements of the SSB are placed or configured in time and/or frequency. For example, the structure may include a number of RBs, a number of symbols, a location of the RBs or symbols, or the like. In this example, the configuration of the PSS and the configuration of the PBCH may be the same between the first RAT and the second RAT, and the SSS may use the same sequence for the first RAT and the second RAT. This may be beneficial because the entire PSS detection chain can be shared between the first RAT and the second RAT at the second UE, memory or double data rate bandwidth for PSS combining is equivalent to memory or double data rate bandwidth for PSS combining in the first RAT, and SSS correlation using fast Hartley transform (FHT) can be used for the first RAT and the second RAT. In this example, the first UE may not detect the SSS of the SSB 810, and the second UE may search for the SSB 810 using two hypotheses: one hypothesis with the first structure and another hypothesis with the second structure. In some aspects, periodicities of the PSS and/or SSS transmissions may be different from one another. For example, a SSS and/or PSS for the first RAT may be transmitted together every Xms, and a periodicity of an SSS and/or PSS for the second RAT may be different than Xms (e.g., the PSS may be transmitted X1 ms, the SSS may be transmitted every X2 ms, and the PBCH may be transmitted every X3 ms, where X1, X2, X3 may all be different, or where two or more of X1, X2, and X3 are equal to one another).

In some aspects, the SSB 810 is associated with the second RAT according to the configuration of the PBCH. For example, a first configuration of the PBCH may be associated with the first RAT (that is, the SSB 805 may use the first configuration of the PBCH), and a second configuration of the PBCH may be associated with the second RAT (that is, the SSB 810 may use the second configuration of the PBCH). The first configuration may differ from the second configuration with regard to at least one of an encoding scheme, a structure (e.g., a physical channel structure such as a number of RBs, a number of symbols, or how the PBCH is frequency division multiplexed or time division multiplexed with the PSS or the SSS), a symbol location, a DMRS configuration (which may include one or more of a DMRS pattern, a DMRS resource element configuration, a DMRS sequence, or DMRS scrambling), a size of the PBCH, or a combination thereof. In some aspects, the first configuration may differ from the second configuration in that the PBCH of the SSB 810 (that is, a PBCH of the second RAT) may be transmitted with a different periodicity than a periodicity of the SSB 805. For example, the SSB 805 (including a PSS, an SSS, and a PBCH having the first configuration) may be transmitted every 20 ms, and the PBCH of the SSB 810 may be transmitted every 40 ms (though other periodicities may also be implemented). In these examples, the configuration of the PSS and the configuration of the SSS may be the same between the first RAT and the second RAT. This may be beneficial because PSS detection blocks and SSS detection blocks can be shared between the first RAT and the second RAT, and because the PBCH can be redesigned with increased flexibility relative to the first RAT. In this example, the first UE may not detect the SSS of the SSB 810, and the second UE may search for the SSB 810 using two hypotheses: one hypothesis with the first configuration of the PBCH and another hypothesis with the second configuration of the PBCH.

In some aspects, the SSB 805 and the SSB 810 may be transmitted with a time offset relative to one another. For example, the SSB 805 and the SSB 810 may be transmitted on a same synchronization raster (such as the synchronization raster described with regard to Tables 1 through 6) and the SSB 810 may be shifted in time relative to the SSB 805 by a time offset. As one example, a default periodicity for the SSB 805 and the SSB 810 may be 20 ms, and the SSB 810 may be transmitted with a 10 ms offset relative to the SSB 805. In such examples, if the SSB 810 uses a different SSB structure than the SSB 805 (as described above), the first UE may detect additional PSS peaks corresponding to SSBs 805 and SSBs 810, and may correlate SSSs of SSBs 805 with PSS peaks of the SSBs 805, thus minimally impacting operation of the first UE. Furthermore, for the first UE and the second UE, PSS combining across SSB bursts may be supported since the SSB 805 and the SSB 810 may be time-aligned and co-located. If the SSB 810 uses a different PSS sequence than the SSB 805, then the second UE may use two hypotheses per synchronization raster GSCN point, as described elsewhere herein.

If the SSB 810 uses a different SSS sequence than the SSB 805 and is time-offset relative to the SSB 805, then PSS combining across SSB bursts may be supported since the SSB 805 and the SSB 810 may be time-aligned and co-located. Furthermore, the first UE may detect additional PSS peaks corresponding to SSBs 805 and SSBs 810, and may prune (e.g., disregard, drop, identify as not associated with the first RAT) the PSS peaks corresponding to SSBs 810 based on SSS correlation. If, after pruning the PSS peaks corresponding to SSBs 810, no PSS peaks remain, the first UE may determine that no cell supporting the first RAT is present. The second UE may perform SSS correlation for the SSB 805 or SSB 810 using two sets of SSS sequences for each detected PSS peak (one set of sequences for the SSB 805 and another set of sequences for the SSB 810), and may thereby determine which SSBs are associated with the first RAT and which SSBs are associated with the second RAT.

If the SSB 810 uses a different PBCH configuration than the SSB 805 and is time-offset relative to the SSB 805, a first UE may detect a cell identifier according to the PSS and the SSS of the SSB 810, and then may fail to decode a PBCH of the SSB 810. In some examples, the first UE may then detect the SSB 805 and successfully decode the PBCH of the SSB 805. In some other aspects, the first UE may move to another cell. In some aspects, the second UE may detect the PSS and SSS of the SSB 805 and the SSB 810, and may decode the PBCH using two hypotheses: one for a PBCH configuration of the SSB 805 and another for a PBCH configuration of the SSB 810.

As shown by reference number 815, the second UE may receive system information in accordance with the SSB 810. For example, the second UE may detect a PSS of the SSB 810, may correlate an SSS of the SSB 810 with the detected PSS, and may identify the PBCH of the SSB 810 accordingly. The second UE may obtain the PBCH (and the MIB), and may receive and decode SIB1 according to the PBCH (e.g., on a PDSCH scheduled in a PDCCH indicated by the PBCH).

As indicated above, FIG. 8 is provided as an example. Other examples may differ from what is described with regard to FIG. 8.

FIG. 9 is a diagram illustrating an example 900 of signaling associated with joint transmission of an SSB for a first RAT and a second RAT, in accordance with the present disclosure. As shown, example 900 includes a first UE (e.g., UE 120) that supports only the first RAT, and a second UE (e.g., UE 120) that supports the second RAT (and optionally the first RAT). Example 900 also includes a network node, which may represent one or more network nodes. The network node transmits an SSB 905. Example 900 describes different ways for the SSB 905 to be associated with the second RAT, such that the first UE does not access a cell associated with the SSB 905. Example 900 may relate to an MRSS band or a refarmed band. For example, the SSB 905 may be transmitted in an MRSS band, as described with regard to FIG. 6, or in a refarmed band or cell, as described with regard to FIG. 7.

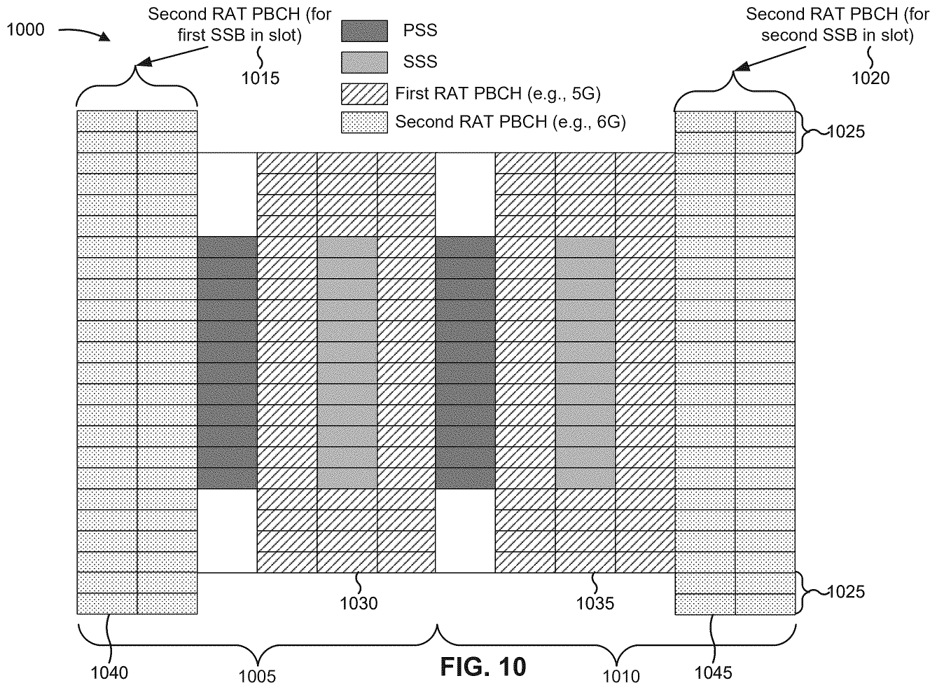

The SSB 905 of example 900 may be associated with (e.g., compatible with) the second RAT. At least part of the SSB 905 may be shared between the first RAT and the second RAT. For example, the SSB 905 may include a PSS that uses a same configuration (e.g., sequence and/or structure) in the first RAT and the second RAT. As another example, the SSB 905 may include an SSS that uses a same configuration (e.g., sequence, structure, and/or location) in the first RAT and the second RAT. In some aspects, a configuration of a PBCH of the SSB 905 may be shared between the first RAT and the second RAT, and the SSB 905 may be differentiated as associated with the first RAT or the second RAT by content of the PBCH, barring information, or whether a PDCCH is scheduled for the UE that receives the SSB 905, as described below. In some other aspects, the SSB 905 may include a first PBCH for the first RAT and a second PBCH for the second RAT, as described in more detail below and with regard to FIG. 10.

In some aspects, the SSB 905 includes a first PBCH and a second PBCH. For example, the first PBCH may be provided on a first set of resources and the second PBCH may be provided on a second set of resources different from the first set of resources. An example is described in connection with FIG. 10, below. Additionally, or alternatively, the first PBCH may be associated with a first periodicity and the second PBCH may be associated with a second periodicity. For example, the first PBCH may occur in odd-indexed instances of the SSB 905 and the second PBCH may occur in even-indexed instances of the SSB 905. As another example, the first PBCH may occur in each SSB 905 and the second PBCH may occur in every other SSB 905. In these examples, the configuration of the PSS and the configuration of the SSS may be the same between the first RAT and the second RAT. This may be beneficial because PSS and SSS detection procedures may be performed only once for a given SSB 905, and because configurations of control resource set #0 (CORESET0), which schedules SIB1, can be separate for the first RAT and the second RAT. Furthermore, this approach provides flexibility for PBCH design in the second RAT, such as PBCH field and sizes. In this example, the first UE may decode the first PBCH, and the second UE may search for the SSB 905 using two hypotheses: one hypothesis for the first PBCH and another hypothesis for the second PBCH.

In some aspects, the SSB 905 may use a structure defined by the first RAT. For example, the SSB 905 may use a PSS configuration, SSS configuration, and PBCH configuration defined by the first RAT. This may be beneficial because UE design and implementation can be shared between the first UE supporting the first RAT and the second supporting the second RAT. In this example, the first UE or the second UE may determine whether a cell associated with the SSB 905 supports the first RAT, the second RAT, or both. For example, one or more bits (e.g., two unused bits) of the PBCH may be used to indicate, to a UE supporting the second RAT, whether the cell supports the first RAT, the second RAT, or both. For the first UE, which does not support the second RAT, the first UE may be barred from accessing a cell associated with the SSB 905, for example, by cell barring information (sometimes referred to herein as “barring information”). For example, the SSB 905 may configure a CORESET0, and a SIB1 may be scheduled within the CORESET0. The CORESET0 may carry barring information intended for UEs supporting the first RAT. For example, the barring information may bar the first UE from accessing the cell of example 900. In this example, a PDCCH for the first RAT and a PDCCH for the second RAT may have a different design and/or encoding, and a cell of the second RAT (as in example 900) may transmit a SIB1 PDSCH in accordance with a PDSCH design of the first RAT. The SIB1 PDSCH could be the same PDSCH, or could be a separate PDSCH, for the first RAT and for the second RAT. One SIB carrying information for both the first RAT and the second RAT may also improve performance indicators, such as network power, on at least cells supporting the first RAT. This approach may implement barring of earlier-RAT UEs (such as 5G UEs) from accessing a cell of a later RAT (such as 6G), even when the SSB 905 of the later RAT is readable by the earlier-RAT UE, with no complexity increase for the earlier-RAT UE. As another example, the first UE may not receive a PDCCH scheduling SIB1. For example, the network node may not transmit the PDCCH for the first RAT. As yet another example, a cell barring information flag field of a PBCH of the SSB 905 (e.g., a MIB of the PBCH, as described in Table 7) may indicate, to the first UE, that the first UE is barred from accessing the cell of example 900. In this example, other bits of the PBCH, such as one or more reserved bits, one or more spare bits, or one or more cyclic redundancy check (CRC) bits, may be used to indicate, to a second UE supporting the second RAT, whether the second UE is barred from accessing the cell of example 900.

As shown by reference number 910, the second UE may detect a PSS of the SSB 905, may correlate an SSS of the SSB 905 with the detected PSS, and may identify the PBCH of the SSB 905 accordingly. The second UE may obtain the PBCH (and the MIB), and may receive and decode SIB1 according to the PBCH (e.g., on a PDSCH scheduled in a PDCCH indicated by the PBCH).

As indicated above, FIG. 9 is provided as an example. Other examples may differ from what is described with regard to FIG. 9.

FIG. 10 is a diagram illustrating an example 1000 of an SSB for shared transmission that includes a first PBCH and a second PBCH in accordance with the present disclosure. Example 1000 illustrates a first SSB 1005 and a second SSB 1010, which may occur in a single slot. Each SSB includes a PSS, an SSS, a first RAT PBCH (for a first RAT such as 5G) and a second RAT PBCH (for a second RAT such as 6G). The first SSB and the second SSB may be examples of the SSB 905 described with regard to FIG. 9.

As shown, in some aspects, a second RAT PBCH 1015 for the first SSB 1005 may be provided in a first two symbols of the slot. As further shown, in some aspects, a second RAT PBCH 1020 for the second SSB 1010 may be provided in a last two symbols of the slot. For example, in most frequency ranges (except FR2-2), at least the first two symbols of the SSB slot and the last two symbols of the SSB slot may be unused in the first RAT, so these symbols can be used for the second RAT PBCHs 1015 and 1020.

Furthermore, as illustrated, for example, by reference number 1025, in some aspects, the second RAT PBCHs 1015 and 1020 may use a different bandwidth than the first RAT PBCHs 1030 and 1035. In some other aspects, the second RAT PBCHs 1015 and 1020 may use a same bandwidth as the first RAT PBCHs 1030 and 1035.

In some aspects, periodicities of PSS and/or SSS transmissions may be different from one another. For example, a SSS and/or PSS for the first RAT may be transmitted together every X ms, and a periodicity of an SSS and/or PSS for the second RAT may be different than X ms (e.g., the PSS may be transmitted X1 ms, the SSS may be transmitted every X2 ms, and the PBCH may be transmitted every X3 ms, where X1, X2, X3 may all be different, or where two or more of X1, X2, and X3 are equal to one another).

The example provided in FIG. 10 is just one example of how second PBCHs may be arranged. In some aspects, for example, the second PBCH 1015 may be placed in the symbols 1040 and 1045. This may be useful if gaps between PBCH symbols improve frequency error estimation. Additionally, or alternatively, a second RAT PBCH 1015/1020 may occupy one or more other unused resources, such as the RBs in the PSS symbols of the first SSB 1005 or the second SSB 1010. Additionally, or alternatively, in some cases, a gap is provided between the first SSB 1005 and the second SSB 1010. In some aspects, this gap may be used for a second RAT PBCH 1015 or 1020.

As indicated above, FIG. 10 is provided as an example. Other examples may differ from what is described with regard to FIG. 10.

FIG. 11 is a diagram illustrating an example process 1100 performed, for example, at a UE or an apparatus of a UE, in accordance with the present disclosure. Example process 1100 is an example where the apparatus or the UE (e.g., UE 120) performs operations associated with synchronization signal block design for multiple radio access technologies.

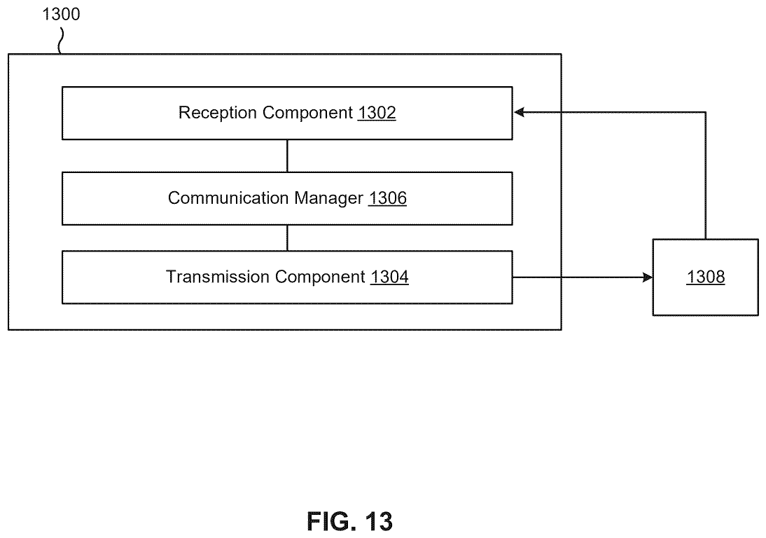

As shown in FIG. 11, in some aspects, process 1100 may include receiving an SSB, wherein the SSB is associated with a first RAT or a second RAT according to at least one of: a configuration of a synchronization signal, a configuration of a broadcast channel of the SSB, whether a control channel is scheduled by the SSB, or barring information associated with the SSB (block 1110). For example, the UE (e.g., using reception component 1302 and/or communication manager 1306, depicted in FIG. 13) may receive an SSB, wherein the SSB is associated with a first RAT or a second RAT according to at least one of: a configuration of a synchronization signal, a configuration of a broadcast channel of the SSB, whether a control channel is scheduled by the SSB, or barring information associated with the SSB, as described above.

As further shown in FIG. 11, in some aspects, process 1100 may include obtaining system information in accordance with the SSB (block 1120). For example, the UE (e.g., using reception component 1302 and/or communication manager 1306, depicted in FIG. 13) may obtain system information in accordance with the SSB, as described above.

Process 1100 may include additional aspects, such as any single aspect or any combination of aspects described below and/or in connection with one or more other processes described elsewhere herein.

In a first aspect, the SSB is associated with the first RAT or the second RAT according to the configuration of the synchronization signal.

In a second aspect, alone or in combination with the first aspect, the synchronization signal is a PSS.

In a third aspect, alone or in combination with one or more of the first and second aspects, a first sequence for the PSS is associated with the first RAT and a second sequence for the PSS is associated with the second RAT.

In a fourth aspect, alone or in combination with one or more of the first through third aspects, the synchronization signal is an SSS.

In a fifth aspect, alone or in combination with one or more of the first through fourth aspects, a first structure of the SSS is associated with the first RAT and a second structure of the SSS is associated with the second RAT.

In a sixth aspect, alone or in combination with one or more of the first through fifth aspects, a first sequence of the SSS is associated with the first RAT and a second sequence of the SSS is associated with the second RAT.

In a seventh aspect, alone or in combination with one or more of the first through sixth aspects, the SSB is associated with the first RAT or the second RAT according to the configuration of the broadcast channel.

In an eighth aspect, alone or in combination with one or more of the first through seventh aspects, the configuration is one of a first configuration or a second configuration, wherein the first configuration is associated with the first RAT and the second configuration is associated with the second RAT, and wherein the first configuration differs from the second configuration with regard to at least one of an encoding scheme, a structure, a symbol location, a demodulation reference signal configuration, or a size.

In a ninth aspect, alone or in combination with one or more of the first through eighth aspects, the SSB is associated with the first RAT or the second RAT according to the barring information associated with the SSB.

In a tenth aspect, alone or in combination with one or more of the first through ninth aspects, the configuration of the synchronization signal and the configuration of the broadcast channel are the same configuration for the first RAT and for the second RAT.

In an eleventh aspect, alone or in combination with one or more of the first through tenth aspects, the SSB indicates a control resource set, and the system information is in the control resource set and carries the barring information.

In a twelfth aspect, alone or in combination with one or more of the first through eleventh aspects, the barring information indicates that UEs associated with the first RAT are barred from accessing a cell associated with the SSB.

In a thirteenth aspect, alone or in combination with one or more of the first through twelfth aspects, a physical control channel scheduling the system information uses a configuration that is compatible with the first RAT and is not compatible with the second RAT.

In a fourteenth aspect, alone or in combination with one or more of the first through thirteenth aspects, a physical shared channel carrying the system information uses a configuration that is compatible with the first RAT and is not compatible with the second RAT.

In a fifteenth aspect, alone or in combination with one or more of the first through fourteenth aspects, a physical shared channel carrying the system information uses a configuration that is compatible with the first RAT and the second RAT.

In a sixteenth aspect, alone or in combination with one or more of the first through fifteenth aspects, the barring information is included in a cell barring information flag field of a master information block.

In a seventeenth aspect, alone or in combination with one or more of the first through sixteenth aspects, one or more bits, not included in the cell barring information flag field, indicate cell barring information for the second RAT.

In an eighteenth aspect, alone or in combination with one or more of the first through seventeenth aspects, the broadcast channel is a first broadcast channel associated with the first RAT and the SSB includes a second broadcast channel associated with the second RAT.

In a nineteenth aspect, alone or in combination with one or more of the first through eighteenth aspects, the first broadcast channel is on a first set of resources and the second broadcast channel is on a second set of resources different than the first set of resources.

In a twentieth aspect, alone or in combination with one or more of the first through nineteenth aspects, the first broadcast channel is associated with a first periodicity and the second broadcast channel is associated with a second periodicity different than the first periodicity.

In a twenty-first aspect, alone or in combination with one or more of the first through twentieth aspects, the SSB is associated with the first RAT or the second RAT according to whether the control channel is scheduled by the SSB.

In a twenty-second aspect, alone or in combination with one or more of the first through twenty-first aspects, the control channel is scheduled only when the SSB is associated with the second RAT.

In a twenty-third aspect, alone or in combination with one or more of the first through twenty-second aspects, SSBs associated with the first RAT use a first synchronization raster, SSBs associated with the second RAT use a second synchronization raster, and a time configuration of the first synchronization raster is offset from a time configuration of the second synchronization raster.

In a twenty-fourth aspect, alone or in combination with one or more of the first through twenty-third aspects, the first RAT is a first-generation-based RAT and the second RAT is a second-generation-based RAT.

In a twenty-fifth aspect, alone or in combination with one or more of the first through twenty-fourth aspects, the first RAT is a 5G RAT and the second RAT is a 6G RAT.

In a twenty-sixth aspect, alone or in combination with one or more of the first through twenty-fifth aspects, receiving the SSB further comprises receiving the SSB using a first hypothesis associated with the first RAT and a second hypothesis associated with the second RAT.

In a twenty-seventh aspect, alone or in combination with one or more of the first through twenty-sixth aspects, the SSB is associated with a multiple RAT spectrum sharing cell.

In a twenty-eighth aspect, alone or in combination with one or more of the first through twenty-seventh aspects, the SSB is associated with a cell that implements only the second RAT.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a network node or an apparatus of a network node, in accordance with the present disclosure. Example process 1200 is an example where the apparatus or the network node (e.g., network node 110) performs operations associated with synchronization signal block design for multiple radio access technologies.

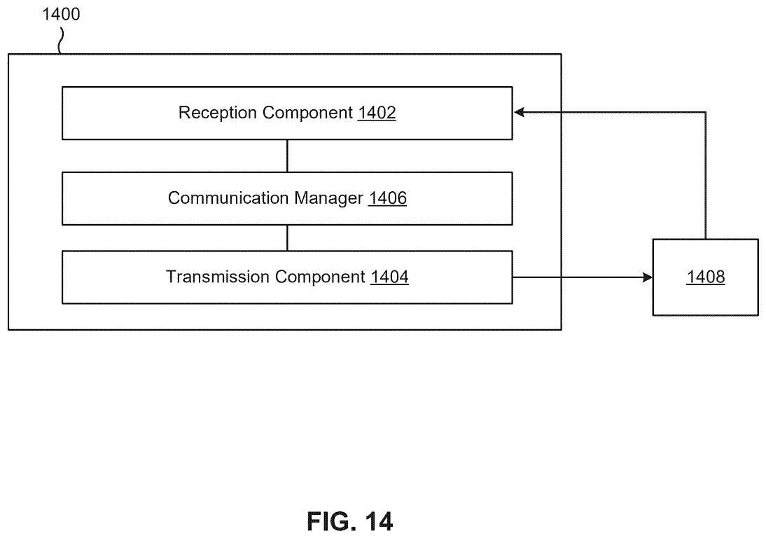

As shown in FIG. 12, in some aspects, process 1200 may include transmitting an SSB, wherein the SSB is associated with a first RAT or a second RAT according to at least one of: a configuration of a synchronization signal, a configuration of a broadcast channel of the SSB, whether a control channel is scheduled by the SSB, or barring information associated with the SSB (block 1210). For example, the network node (e.g., using transmission component 1404 and/or communication manager 1406, depicted in FIG. 14) may transmit an SSB, wherein the SSB is associated with a first RAT or a second RAT according to at least one of: a configuration of a synchronization signal, a configuration of a broadcast channel of the SSB, whether a control channel is scheduled by the SSB, or barring information associated with the SSB, as described above.

As further shown in FIG. 12, in some aspects, process 1200 may include transmitting system information in accordance with the SSB (block 1220). For example, the network node (e.g., using transmission component 1404 and/or communication manager 1406, depicted in FIG. 14) may transmit system information in accordance with the SSB, as described above.

Process 1200 may include additional aspects, such as any single aspect or any combination of aspects described below and/or in connection with one or more other processes described elsewhere herein.

In a first aspect, the SSB is associated with the first RAT or the second RAT according to the configuration of the synchronization signal.

In a second aspect, alone or in combination with the first aspect, the synchronization signal is a PSS.

In a third aspect, alone or in combination with one or more of the first and second aspects, a first sequence for the PSS is associated with the first RAT and a second sequence for the PSS is associated with the second RAT.

In a fourth aspect, alone or in combination with one or more of the first through third aspects, the synchronization signal is an SSS.

In a fifth aspect, alone or in combination with one or more of the first through fourth aspects, a first structure of the SSS is associated with the first RAT and a second structure of the SSS is associated with the second RAT.

In a sixth aspect, alone or in combination with one or more of the first through fifth aspects, a first sequence of the SSS is associated with the first RAT and a second sequence of the SSS is associated with the second RAT.

In a seventh aspect, alone or in combination with one or more of the first through sixth aspects, the SSB is associated with the first RAT or the second RAT according to the configuration of the broadcast channel.

In an eighth aspect, alone or in combination with one or more of the first through seventh aspects, the configuration is one of a first configuration or a second configuration, wherein the first configuration is associated with the first RAT and the second configuration is associated with the second RAT, and wherein the first configuration differs from the second configuration with regard to at least one of an encoding scheme, a structure, a symbol location, a demodulation reference signal configuration, or a size.

In a ninth aspect, alone or in combination with one or more of the first through eighth aspects, the SSB is associated with the first RAT or the second RAT according to the barring information associated with the SSB.

In a tenth aspect, alone or in combination with one or more of the first through ninth aspects, the configuration of the synchronization signal and the configuration of the broadcast channel are the same configuration for the first RAT and for the second RAT.

In an eleventh aspect, alone or in combination with one or more of the first through tenth aspects, the SSB indicates a control resource set, and the system information is in the control resource set and carries the barring information.

In a twelfth aspect, alone or in combination with one or more of the first through eleventh aspects, the barring information indicates that UEs associated with the first RAT are barred from accessing a cell associated with the SSB.

In a thirteenth aspect, alone or in combination with one or more of the first through twelfth aspects, a physical control channel scheduling the system information uses a configuration that is compatible with the first RAT and is not compatible with the second RAT.

In a fourteenth aspect, alone or in combination with one or more of the first through thirteenth aspects, a physical shared channel carrying the system information uses a configuration that is compatible with the first RAT and not the second RAT.

In a fifteenth aspect, alone or in combination with one or more of the first through fourteenth aspects, a physical shared channel carrying the system information uses a configuration that is compatible with the first RAT and the second RAT.

In a sixteenth aspect, alone or in combination with one or more of the first through fifteenth aspects, the barring information is included in a cell barring information flag field of a master information block.

In a seventeenth aspect, alone or in combination with one or more of the first through sixteenth aspects, one or more bits, not included in the cell barring information flag field, indicate cell barring information for the second RAT.

In an eighteenth aspect, alone or in combination with one or more of the first through seventeenth aspects, the broadcast channel is a first broadcast channel associated with the first RAT and the SSB includes a second broadcast channel associated with the second RAT.

In a nineteenth aspect, alone or in combination with one or more of the first through eighteenth aspects, the first broadcast channel is on a first set of resources and the second broadcast channel is on a second set of resources different than the first set of resources.

In a twentieth aspect, alone or in combination with one or more of the first through nineteenth aspects, the first broadcast channel is associated with a first periodicity and the second broadcast channel is associated with a second periodicity different than the first periodicity.

In a twenty-first aspect, alone or in combination with one or more of the first through twentieth aspects, the SSB is associated with the first RAT or the second RAT according to whether the control channel is scheduled by the SSB.

In a twenty-second aspect, alone or in combination with one or more of the first through twenty-first aspects, the control channel is scheduled only when the SSB is associated with the second RAT.

In a twenty-third aspect, alone or in combination with one or more of the first through twenty-second aspects, SSBs associated with the first RAT use a first synchronization raster, SSBs associated with the second RAT use a second synchronization raster, and a time configuration of the first synchronization raster is offset from a time configuration of the second synchronization raster.

In a twenty-fourth aspect, alone or in combination with one or more of the first through twenty-third aspects, the first RAT is a first-generation-based RAT and the second RAT is a second-generation-based RAT.

In a twenty-fifth aspect, alone or in combination with one or more of the first through twenty-fourth aspects, the first RAT is a 5G RAT and the second RAT is a 6G RAT.

In a twenty-sixth aspect, alone or in combination with one or more of the first through twenty-fifth aspects, the synchronization signal includes a primary synchronization signal and a secondary synchronization signal, and the broadcast channel includes a physical broadcast channel.

In a twenty-seventh aspect, alone or in combination with one or more of the first through twenty-sixth aspects, the SSB is associated with a multiple RAT spectrum sharing cell.

In a twenty-eighth aspect, alone or in combination with one or more of the first through twenty-seventh aspects, the SSB is associated with a cell that implements only the second RAT.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication, in accordance with the present disclosure. The apparatus 1300 may be a UE, or a UE may include the apparatus 1300. In some aspects, the apparatus 1300 includes a reception component 1302, a transmission component 1304, and/or a communication manager 1306, which may be in communication with one another (for example, via one or more buses and/or one or more other components). In some aspects, the communication manager 1306 is the communication manager 140 described in connection with FIG. 1. As shown, the apparatus 1300 may communicate with another apparatus 1308, such as a UE or a network node (such as a CU, a DU, an RU, or a base station), using the reception component 1302 and the transmission component 1304.

In some aspects, the apparatus 1300 may be configured to perform one or more operations described herein in connection with FIGS. 4-10. Additionally, or alternatively, the apparatus 1300 may be configured to perform one or more processes described herein, such as process 1100 of FIG. 11, or a combination thereof. In some aspects, the apparatus 1300 and/or one or more components shown in FIG. 13 may include one or more components of the UE described in connection with FIG. 2. Additionally, or alternatively, one or more components shown in FIG. 13 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1300. In some aspects, the reception component 1302 may include one or more antennas, one or more modems, one or more demodulators, one or more MIMO detectors, one or more receive processors, one or more controllers/processors, one or more memories, or a combination thereof, of the UE described in connection with FIG. 2.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications (such as filtering, amplification, modulation, digital-to-analog conversion, multiplexing, interleaving, mapping, or encoding, among other examples), and may transmit the processed signals to the apparatus 1308. In some aspects, the transmission component 1304 may include one or more antennas, one or more modems, one or more modulators, one or more transmit MIMO processors, one or more transmit processors, one or more controllers/processors, one or more memories, or a combination thereof, of the UE described in connection with FIG. 2. In some aspects, the transmission component 1304 may be co-located with the reception component 1302 in one or more transceivers.

The communication manager 1306 may support operations of the reception component 1302 and/or the transmission component 1304. For example, the communication manager 1306 may receive information associated with configuring reception of communications by the reception component 1302 and/or transmission of communications by the transmission component 1304. Additionally, or alternatively, the communication manager 1306 may generate and/or provide control information to the reception component 1302 and/or the transmission component 1304 to control reception and/or transmission of communications.

The reception component 1302 may receive an SSB, wherein the SSB is associated with a first RAT or a second RAT according to at least one of a configuration of a synchronization signal, a configuration of a broadcast channel of the SSB, whether a control channel is scheduled by the SSB, or barring information associated with the SSB. The reception component 1302 may obtain system information in accordance with the SSB.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication, in accordance with the present disclosure. The apparatus 1400 may be a network node, or a network node may include the apparatus 1400. In some aspects, the apparatus 1400 includes a reception component 1402, a transmission component 1404, and/or a communication manager 1406, which may be in communication with one another (for example, via one or more buses and/or one or more other components). In some aspects, the communication manager 1406 is the communication manager 150 described in connection with FIG. 1. As shown, the apparatus 1400 may communicate with another apparatus 1408, such as a UE or a network node (such as a CU, a DU, an RU, or a base station), using the reception component 1402 and the transmission component 1404.

In some aspects, the apparatus 1400 may be configured to perform one or more operations described herein in connection with FIGS. 4-10. Additionally, or alternatively, the apparatus 1400 may be configured to perform one or more processes described herein, such as process 1200 of FIG. 12, or a combination thereof. In some aspects, the apparatus 1400 and/or one or more components shown in FIG. 14 may include one or more components of the network node described in connection with FIG. 2. Additionally, or alternatively, one or more components shown in FIG. 14 may be implemented within one or more components described in connection with FIG. 2. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1400. In some aspects, the reception component 1402 may include one or more antennas, one or more modems, one or more demodulators, one or more MIMO detectors, one or more receive processors, one or more controllers/processors, one or more memories, or a combination thereof, of the network node described in connection with FIG. 2. In some aspects, the reception component 1402 and/or the transmission component 1404 may include or may be included in a network interface. The network interface may be configured to obtain and/or output signals for the apparatus 1400 via one or more communications links, such as a backhaul link, a midhaul link, and/or a fronthaul link.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1408. In some aspects, the transmission component 1404 may include one or more antennas, one or more modems, one or more modulators, one or more transmit MIMO processors, one or more transmit processors, one or more controllers/processors, one or more memories, or a combination thereof, of the network node described in connection with FIG. 2. In some aspects, the transmission component 1404 may be co-located with the reception component 1402 in one or more transceivers.

The communication manager 1406 may support operations of the reception component 1402 and/or the transmission component 1404. For example, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The transmission component 1404 may transmit an SSB, wherein the SSB is associated with a first RAT or a second RAT according to at least one of a configuration of a synchronization signal, a configuration of a broadcast channel of the SSB, whether a control channel is scheduled by the SSB, or barring information associated with the SSB. The transmission component 1404 may transmit system information in accordance with the SSB.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a user equipment (UE), comprising: receiving a synchronization signal block (SSB), wherein the SSB is associated with a first radio access technology (RAT) or a second RAT according to at least one of: a configuration of a synchronization signal, a configuration of a broadcast channel of the SSB, whether a control channel is scheduled by the SSB, or barring information associated with the SSB; and obtaining system information in accordance with the SSB.

Aspect 2: The method of Aspect 1, wherein the SSB is associated with the first RAT or the second RAT according to the configuration of the synchronization signal.

Aspect 3: The method of Aspect 2, wherein the synchronization signal is a primary synchronization signal (PSS).

Aspect 4: The method of Aspect 3, wherein a first sequence for the PSS is associated with the first RAT and a second sequence for the PSS is associated with the second RAT.

Aspect 5: The method of Aspect 2, wherein the synchronization signal is a secondary synchronization signal (SSS).

Aspect 6: The method of Aspect 5, wherein a first structure of the SSS is associated with the first RAT and a second structure of the SSS is associated with the second RAT.

Aspect 7: The method of Aspect 5, wherein a first sequence of the SSS is associated with the first RAT and a second sequence of the SSS is associated with the second RAT.

Aspect 8: The method of any of Aspects 1-7, wherein the SSB is associated with the first RAT or the second RAT according to the configuration of the broadcast channel.

Aspect 9: The method of Aspect 8, wherein the configuration is one of a first configuration or a second configuration, wherein the first configuration is associated with the first RAT and the second configuration is associated with the second RAT, and wherein the first configuration differs from the second configuration with regard to at least one of: an encoding scheme, a structure, a symbol location, a demodulation reference signal configuration, or a size.

Aspect 10: The method of any of Aspects 1-9, wherein the SSB is associated with the first RAT or the second RAT according to the barring information associated with the SSB.

Aspect 11: The method of Aspect 10, wherein the configuration of the synchronization signal and the configuration of the broadcast channel are the same configuration for the first RAT and for the second RAT.

Aspect 12: The method of Aspect 10, wherein the SSB indicates a control resource set, and wherein the system information is in the control resource set and carries the barring information.

Aspect 13: The method of Aspect 12, wherein the barring information indicates that UEs associated with the first RAT are barred from accessing a cell associated with the SSB.

Aspect 14: The method of Aspect 10, wherein a physical control channel scheduling the system information uses a configuration that is compatible with the first RAT and is not compatible with the second RAT.

Aspect 15: The method of Aspect 10, wherein a physical shared channel carrying the system information uses a configuration that is compatible with the first RAT and is not compatible with the second RAT.

Aspect 16: The method of Aspect 10, wherein a physical shared channel carrying the system information uses a configuration that is compatible with the first RAT and the second RAT.

Aspect 17: The method of Aspect 10, wherein the barring information is included in a cell barring information flag field of a master information block.

Aspect 18: The method of Aspect 17, wherein one or more bits, not included in the cell barring information flag field, indicate cell barring information for the second RAT.

Aspect 19: The method of any of Aspects 1-18, wherein the broadcast channel is a first broadcast channel associated with the first RAT and the SSB includes a second broadcast channel associated with the second RAT.

Aspect 20: The method of Aspect 19, wherein the first broadcast channel is on a first set of resources and the second broadcast channel is on a second set of resources different than the first set of resources.

Aspect 21: The method of Aspect 19, wherein the first broadcast channel is associated with a first periodicity and the second broadcast channel is associated with a second periodicity different than the first periodicity.

Aspect 22: The method of any of Aspects 1-21, wherein the SSB is associated with the first RAT or the second RAT according to whether the control channel is scheduled by the SSB.

Aspect 23: The method of Aspect 22, wherein the control channel is scheduled only when the SSB is associated with the second RAT.

Aspect 24: The method of any of Aspects 1-23, wherein SSBs associated with the first RAT use a first synchronization raster, SSBs associated with the second RAT use a second synchronization raster, and a time configuration of the first synchronization raster is offset from a time configuration of the second synchronization raster.

Aspect 25: The method of any of Aspects 1-24, wherein the first RAT is a first-generation-based RAT and the second RAT is a second-generation-based RAT.

Aspect 26: The method of Aspect 25, wherein the first RAT is a 5G RAT and the second RAT is a 6G RAT.

Aspect 27: The method of any of Aspects 1-26, wherein receiving the SSB further comprises receiving the SSB using a first hypothesis associated with the first RAT and a second hypothesis associated with the second RAT.

Aspect 28: The method of any of Aspects 1-27, wherein the SSB is associated with a multiple RAT spectrum sharing cell.

Aspect 29: The method of any of Aspects 1-28, wherein the SSB is associated with a cell that implements only the second RAT.

Aspect 30: A method of wireless communication performed by a network node, comprising: transmitting a synchronization signal block (SSB), wherein the SSB is associated with a first radio access technology (RAT) or a second RAT according to at least one of: a configuration of a synchronization signal, a configuration of a broadcast channel of the SSB, whether a control channel is scheduled by the SSB, or barring information associated with the SSB; and transmitting system information in accordance with the SSB.

Aspect 31: The method of Aspect 30, wherein the SSB is associated with the first RAT or the second RAT according to the configuration of the synchronization signal.

Aspect 32: The method of Aspect 31, wherein the synchronization signal is a primary synchronization signal (PSS).

Aspect 33: The method of Aspect 32, wherein a first sequence for the PSS is associated with the first RAT and a second sequence for the PSS is associated with the second RAT.

Aspect 34: The method of Aspect 31, wherein the synchronization signal is a secondary synchronization signal (SSS).

Aspect 35: The method of Aspect 34, wherein a first structure of the SSS is associated with the first RAT and a second structure of the SSS is associated with the second RAT.

Aspect 36: The method of Aspect 34, wherein a first sequence of the SSS is associated with the first RAT and a second sequence of the SSS is associated with the second RAT.

Aspect 37: The method of any of Aspects 30-36, wherein the SSB is associated with the first RAT or the second RAT according to the configuration of the broadcast channel.

Aspect 38: The method of Aspect 37, wherein the configuration is one of a first configuration or a second configuration, wherein the first configuration is associated with the first RAT and the second configuration is associated with the second RAT, and wherein the first configuration differs from the second configuration with regard to at least one of: an encoding scheme, a structure, a symbol location, a demodulation reference signal configuration, or a size.

Aspect 39: The method of any of Aspects 30-38, wherein the SSB is associated with the first RAT or the second RAT according to the barring information associated with the SSB.

Aspect 40: The method of Aspect 39, wherein the configuration of the synchronization signal and the configuration of the broadcast channel are the same configuration for the first RAT and for the second RAT.

Aspect 41: The method of Aspect 39, wherein the SSB indicates a control resource set, and wherein the system information is in the control resource set and carries the barring information.

Aspect 42: The method of Aspect 41, wherein the barring information indicates that UEs associated with the first RAT are barred from accessing a cell associated with the SSB.

Aspect 43: The method of Aspect 39, wherein a physical control channel scheduling the system information uses a configuration that is compatible with the first RAT and is not compatible with the second RAT.

Aspect 44: The method of Aspect 39, wherein a physical shared channel carrying the system information uses a configuration that is compatible with the first RAT and not the second RAT.

Aspect 45: The method of Aspect 39, wherein a physical shared channel carrying the system information uses a configuration that is compatible with the first RAT and the second RAT.

Aspect 46: The method of Aspect 39, wherein the barring information is included in a cell barring information flag field of a master information block.

Aspect 47: The method of Aspect 46, wherein one or more bits, not included in the cell barring information flag field, indicate cell barring information for the second RAT.

Aspect 48: The method of any of Aspects 30-47, wherein the broadcast channel is a first broadcast channel associated with the first RAT and the SSB includes a second broadcast channel associated with the second RAT.

Aspect 49: The method of Aspect 48, wherein the first broadcast channel is on a first set of resources and the second broadcast channel is on a second set of resources different than the first set of resources.

Aspect 50: The method of Aspect 48, wherein the first broadcast channel is associated with a first periodicity and the second broadcast channel is associated with a second periodicity different than the first periodicity.

Aspect 51: The method of any of Aspects 30-50, wherein the SSB is associated with the first RAT or the second RAT according to whether the control channel is scheduled by the SSB.

Aspect 52: The method of Aspect 51, wherein the control channel is scheduled only when the SSB is associated with the second RAT.

Aspect 53: The method of any of Aspects 30-52, wherein SSBs associated with the first RAT use a first synchronization raster, SSBs associated with the second RAT use a second synchronization raster, and a time configuration of the first synchronization raster is offset from a time configuration of the second synchronization raster.

Aspect 54: The method of any of Aspects 30-53, wherein the first RAT is a first-generation-based RAT and the second RAT is a second-generation-based RAT.

Aspect 55: The method of Aspect 54, wherein the first RAT is a 5G RAT and the second RAT is a 6G RAT.

Aspect 56: The method of any of Aspects 30-55, wherein the synchronization signal includes a primary synchronization signal and a secondary synchronization signal, and wherein the broadcast channel includes a physical broadcast channel.

Aspect 57: The method of any of Aspects 30-56, wherein the SSB is associated with a multiple RAT spectrum sharing cell.

Aspect 58: The method of any of Aspects 30-57, wherein the SSB is associated with a cell that implements only the second RAT.

Aspect 59: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-58.

Aspect 60: An apparatus for wireless communication at a device, the apparatus comprising one or more memories and one or more processors coupled to the one or more memories, the one or more processors configured to cause the device to perform the method of one or more of Aspects 1-58.

Aspect 61: An apparatus for wireless communication, the apparatus comprising at least one means for performing the method of one or more of Aspects 1-58.

Aspect 62: A non-transitory computer-readable medium storing code for wireless communication, the code comprising instructions executable by one or more processors to perform the method of one or more of Aspects 1-58.

Aspect 63: A non-transitory computer-readable medium storing a set of instructions for wireless communication, the set of instructions comprising one or more instructions that, when executed by one or more processors of a device, cause the device to perform the method of one or more of Aspects 1-58.

Aspect 64: A device for wireless communication, the device comprising a processing system that includes one or more processors and one or more memories coupled with the one or more processors, the processing system configured to cause the device to perform the method of one or more of Aspects 1-58.

Aspect 65: An apparatus for wireless communication at a device, the apparatus comprising one or more memories and one or more processors coupled to the one or more memories, the one or more processors individually or collectively configured to cause the device to perform the method of one or more of Aspects 1-58.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware or a combination of hardware and at least one of software or firmware. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise. As used herein, a “processor” is implemented in hardware or a combination of hardware and software. It will be apparent that systems or methods described herein may be implemented in different forms of hardware or a combination of hardware and software. The actual specialized control hardware or software code used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” and similar terms are intended to be open-ended terms that do not limit an element that they modify (for example, an element “having” A may also have B). Further, the phrase “based on” is intended to mean “based on or otherwise in association with” unless explicitly stated otherwise. Also, as used herein, the term “or” is intended to be inclusive when used in a series and may be used interchangeably with “and/or,” unless explicitly stated otherwise (for example, if used in combination with “either” or “only one of”). It should be understood that “one or more” is equivalent to “at least one.”

Even though particular combinations of features are recited in the claims or disclosed in the specification, these combinations are not intended to limit the disclosure of various aspects. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
receive a synchronization signal block (SSB), wherein the SSB is associated with a first radio access technology (RAT) or a second RAT according to at least one of a configuration of a synchronization signal of the SSB, a configuration of a broadcast channel of the SSB, whether a control channel is scheduled by the SSB, or barring information associated with the SSB; and
obtain system information in accordance with the SSB.

2. The apparatus of claim 1, wherein the SSB is associated with the first RAT or the second RAT according to the configuration of the synchronization signal.

3. The apparatus of claim 2, wherein the synchronization signal is a primary synchronization signal (PSS).

4. The apparatus of claim 3, wherein the configuration of the synchronization signal indicates a sequence for the PSS, wherein a first sequence for the PSS is associated with the first RAT and a second sequence for the PSS is associated with the second RAT.

5. The apparatus of claim 2, wherein the synchronization signal is a secondary synchronization signal (SSS).

6. The apparatus of claim 5, wherein the configuration of the synchronization signal indicates a structure for the SSS, wherein a first structure of the SSS is associated with the first RAT and a second structure of the SSS is associated with the second RAT.

7. The apparatus of claim 5, wherein the configuration of the synchronization signal indicates a sequence for the SSS, wherein a first sequence of the SSS is associated with the first RAT and a second sequence of the SSS is associated with the second RAT.

8. The apparatus of claim 1, wherein the SSB is associated with the first RAT or the second RAT according to the configuration of the broadcast channel.

9. The apparatus of claim 8, wherein the configuration of the broadcast channel is one of a first configuration or a second configuration, wherein the first configuration is associated with the first RAT and the second configuration is associated with the second RAT, and wherein the first configuration differs from the second configuration with regard to at least one of:
an encoding scheme of the broadcast channel,
a structure of the broadcast channel,
a symbol location of the broadcast channel,
a demodulation reference signal configuration of the broadcast channel, or
a size of the broadcast channel.

10. The apparatus of claim 1, wherein the SSB is associated with the first RAT or the second RAT further according to a periodicity of at least one of the synchronization signal or the broadcast channel.

11. The apparatus of claim 1, wherein the SSB is associated with the first RAT or the second RAT according to the barring information associated with the SSB.

12. The apparatus of claim 11, wherein the SSB indicates a control resource set, and wherein the system information is in the control resource set and carries the barring information.

13. The apparatus of claim 12, wherein the barring information indicates that UEs associated with the first RAT are barred from accessing a cell associated with the SSB.

14. The apparatus of claim 11, wherein the barring information is included in a cell barring information flag field of a master information block.

15. The apparatus of claim 14, wherein one or more bits, not included in the cell barring information flag field, indicate cell barring information for the second RAT.

16. The apparatus of claim 1, wherein the broadcast channel is a first broadcast channel associated with the first RAT and the SSB includes a second broadcast channel associated with the second RAT.

17. The apparatus of claim 16, wherein the first broadcast channel is on a first set of resources and the second broadcast channel is on a second set of resources different than the first set of resources.

18. The apparatus of claim 1, wherein the SSB is associated with the first RAT or the second RAT according to whether the control channel is scheduled by the SSB, wherein the control channel is scheduled only when the SSB is associated with the second RAT.

19. The apparatus of claim 1, wherein the SSB is associated with the first RAT or the second RAT according to a time configuration of the SSB.

20. An apparatus for wireless communication at a network node, comprising:
one or more memories; and
one or more processors, coupled to the one or more memories, configured to cause the network node to:
transmit a synchronization signal block (SSB), wherein the SSB is associated with a first radio access technology (RAT) or a second RAT according to at least one of a configuration of a synchronization signal of the SSB, a configuration of a broadcast channel of the SSB, whether a control channel is scheduled by the SSB, or barring information associated with the SSB; and
transmit system information in accordance with the SSB.

21. The apparatus of claim 20, wherein the SSB is associated with the first RAT or the second RAT according to the configuration of the synchronization signal.

22. The apparatus of claim 20, wherein the SSB is associated with the first RAT or the second RAT according to the configuration of the broadcast channel.

23. The apparatus of claim 20, wherein the SSB is associated with the first RAT or the second RAT according to the barring information associated with the SSB.

24. The apparatus of claim 20, wherein the broadcast channel is a first broadcast channel associated with the first RAT and the SSB includes a second broadcast channel associated with the second RAT.

25. The apparatus of claim 20, wherein the SSB is associated with the first RAT or the second RAT according to whether the control channel is scheduled by the SSB.

26. The apparatus of claim 20, wherein the SSB is associated with the first RAT or the second RAT according to a time configuration of the SSB.

27. A method of wireless communication performed by a user equipment (UE), comprising:
receiving a synchronization signal block (SSB), wherein the SSB is associated with a first radio access technology (RAT) or a second RAT according to at least one of a configuration of a synchronization signal of the SSB, a configuration of a broadcast channel of the SSB, whether a control channel is scheduled by the SSB, or barring information associated with the SSB; and
obtaining system information in accordance with the SSB.

28. The method of claim 27, wherein the SSB is associated with the first RAT or the second RAT according to the configuration of the synchronization signal.

29. A method of wireless communication performed by a network node, comprising:
transmitting a synchronization signal block (SSB), wherein the SSB is associated with a first radio access technology (RAT) or a second RAT according to at least one of a configuration of a synchronization signal of the SSB, a configuration of a broadcast channel of the SSB, whether a control channel is scheduled by the SSB, or barring information associated with the SSB; and
transmitting system information in accordance with the SSB.

30. The method of claim 29, wherein the SSB is associated with the first RAT or the second RAT according to the configuration of the synchronization signal.
